(19) United States
(12) Patent Application Publication
(10) Pub. No.: US 2026/0111291 A1
(43) Pub. Date: Apr. 23, 2026

(54) PREDICTIVE TOOL SEQUENCING BASED ON CONTEXT AWARENESS

(71) Applicant: International Business Machines Corporation, Armonk, NY (US)

(72) Inventors: Matan Vetzler, Givat Shmuel (IL); Koren Ran Lazar, Jerusalem (IL); Guy Uziel, Rishon Lezion (IL); Ateret Anaby - Tavor, Givat Ada (IL); Eran Hirsch, Kfar Saba (IL)

(21) Appl. No.: 18/920,218

(22) Filed: Oct. 18, 2024

(51) Int. Cl. G06F 9/54

(52) U.S. Cl. CPC G06F 9/54; G06F 2209/543

(57) ABSTRACT

One or more systems, devices, computer program products and/or computer-implemented methods of use provided herein relate to predictive tool sequencing based on context awareness. In this regard, a system can further comprise a processor that can execute the computer executable components stored in the memory, where the computer executable components can comprise an access component that can access a context window comprising a sequence of application programming interface (API) tools. The computer executable components can further comprise a prediction component that can predict an API tool for a defined position within the context window, based on a context provided by the sequence of API tools.

### BACKGROUND

The subject disclosure relates to machine learning and, more specifically, to predictive tool sequencing based on context awareness.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable a context-aware predictive tool sequencing approach that does not rely on a defined objective are discussed.

According to an embodiment, a system is provided. The system can comprise a memory that can store computer executable components. The system can further comprise a processor that can execute the computer executable components stored in the memory, where the computer executable components can comprise an access component that can access a context window comprising a sequence of application programming interface (API) tools. The computer executable components can further comprise a prediction component that can predict an API tool for a defined position within the context window, based on a context provided by the sequence of API tools.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can predict an API tool (or API) that can be employed at a defined position within a context window, in accordance with one or more embodiments described herein.

FIG. 2 illustrates another block diagram of an example, non-limiting system that can predict an API tool that can be employed at a defined position within a context window, in accordance with one or more embodiments described herein.

FIG. 3 illustrates diagrams of an example, non-limiting tool chain and an example, non-limiting method that can predict one or more API tools within the tool chain via a previous best action (PBA) approach, in accordance with one or more embodiments described herein.

FIG. 4 illustrates a diagram of an example, non-limiting tool chain of API tools that can be employed to generate a training dataset to train an algorithm to predict an API tool within a sub-chain of API tools (or sub-chain), in accordance with one or more embodiments described herein.

FIGS. 5-11 illustrate diagrams of example, non-limiting steps associated with training an algorithm to predict an API tool within a sub-chain of API tools, in accordance with one or more embodiments described herein.

FIG. 12 illustrates flow diagrams of example, non-limiting steps that can be employed by an algorithm to predict an API tool within a sub-chain of API tools, in accordance with one or more embodiments described herein.

FIG. 13 illustrates flow diagrams of example, non-limiting methods that can retrieve the best API tools for a sequence given a query, in accordance with one or more embodiments described herein.

FIG. 14 illustrates a block diagram of an example, non-limiting API platform.

FIG. 15 illustrates a flow diagram of an example, non-limiting method that can employ the API platform illustrated in FIG. 14 to generate a training dataset, in accordance with one or more embodiments described herein.

FIGS. 16 and 17 illustrate example, non-limiting graphs that show the results of evaluating the performance of an algorithm trained to predict an API tool within a sub-chain of API tools, in accordance with one or more embodiments described herein.

FIG. 18 illustrates a flow diagram of an example, non-limiting method that, given a query, can retrieve the best API tools for a sub-chain of API tools, and further illustrates evaluation metrics corresponding to the non-limiting method, in accordance with one or more embodiments described herein.

FIGS. 19-23 illustrate flow diagrams of example, non-limiting steps of a method that, given a query, can retrieve the best API tool for a sub-chain of API tools, in accordance with one or more embodiments described herein.

FIG. 24 illustrates a flow diagram of an example, non-limiting method that, given a query, can retrieve a subset of the best API tools, in accordance with one or more embodiments described herein.

FIG. 25 illustrates flow diagrams of example, non-limiting methods that can predict an API tool that can be employed at a defined position within a context window, in accordance with one or more embodiments described herein.

FIG. 26 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A tool chain refers to a sequence or combination of tools (e.g., software tools, APSs or API tools, etc.) and processes arranged to achieve a specific objective or perform a particular task that involves the execution of multiple steps towards generate a solution. Each tool within a tool chain is designed to execute a specific function and contributes to the overall goal/end goal of the tool chain. For example, the task of teaching an individual to make good cocktails and of providing information on the nutritional values of different cocktails can be divided into multiple sub-tasks or steps, wherein each sub-task can be performed by a tool within a tool chain. That is, each tool can be responsible for performing a sub-task. Further, each tool can access one or more external knowledge sources to perform a sub-task. For example, the first tool in the tool chain can be a cocktail recommendation tool that can perform the sub-task of generating a list of excellent and tasty cocktails by accessing a database or repository of cocktail recipes and preferences. The second tool in the tool chain can be a cocktail recipe tool that perform the sub-task of accessing the list of cocktails generated by the cocktail recommendation tool and providing detailed information on how to prepare each cocktail by accessing a database or repository of detailed cocktail recipes, including ingredient quantities and preparation steps. The third tool in the tool chain can be a nutritional analysis tool that can perform the sub-task of accessing the instructions and ingredients for each cocktail and return their nutritional values by utilizing a database of nutritional information for various ingredients and their quantities. Thus, a tool chain can be visualized as a series of interconnected tools, wherein the output of one tool becomes the input for the next tool.

In a broader sense, the concept of a tool chain can be applied to various domains where a sequence of tools or processes can collaboratively work towards achieving a specific end goal or solving a problem. Existing solutions directed to contextual tool sequencing often lack adaptability and flexibility. Some examples of such existing solutions include linear task planning systems and recommendation algorithms for sequential actions. Traditional linear task planning systems can struggle with dynamic user preferences, and recommendation algorithms can fail to capture the intricacies of partial tool chain contexts. Other existing solutions rely on defined objectives to infer the context associated with a tool sequence; however, a defined objective such as a query is not always available for certain tasks. Thus, a more adaptable and flexible approach to contextual tool sequencing can be desirable.

Various embodiments of the present disclosure can be implemented to produce a solution to one or more of these problems. Embodiments described herein include systems, computer-implemented methods, and computer program products that can dynamically predict API tools within a sequence of API tools without employing a query or a defined objective. Embodiments of the present disclosure can present a versatile and efficient approach to understand/comprehend/infer the objective of a contextualized task being performed by an end entity (e.g., hardware, software, machine, AI, neural network and/or user) and retrieve, based on the inferred objective, the most suitable API tools within the contextualized task. For example, in various embodiments described herein, methods and techniques are disclosed that can predict an API tool as a previous best action (PBA) or next best action (NBA) within a sequence of API tools directed to a specific objective, based solely on existing API tools within the sequence. For example, in various embodiments, a tool prediction model is provided, wherein the tool prediction model is directed to the specific task of discerning and predicting a PBA or an NBA that can be employed at a specific/defined position within a sequence of API tools by leveraging the context evident from API tools already present (e.g., previously predicted or selected) in the sequence of API tools, even in the absence of an explicitly stated user objective. Herein, PBA or NBA refers to an API tool because an API tool is directed to performing a specific action. For example, an API tool can be directed to generating a list of comedy movies. Accordingly, the terms “API tool,” “action,” “skill,” and “functionality” are used interchangeably throughout this specification unless otherwise specified. Thus, the methods and techniques disclosed herein can address the challenge of predicting the most relevant API tool in a given sequence of API tools (e.g., a tool chain of API tools, a sub-chain of API tools derived from the tool chain, etc.), wherein each API tool can be executable to perform a specific action.

In various embodiments, the tool prediction model can be a shortlisting algorithm (also known as API search shortlister or shortlister retriever) that can efficiently narrow a search space from potentially thousands or tens of thousands of API tools to only tens or hundreds of API tools. The tool prediction model can employ a prediction component. In one or more embodiments, the prediction component can be a dense retriever model that can be trained by a training component to predict the most suitable API tool that can be inserted at a defined position within a context window (i.e., a sub-chain derived from a tool chain of API tools). In various embodiments, to train the dense retriever model, the training component can employ a training dataset comprising API tool sequences, wherein respective API tools can be geared towards respective distinct goals. Further, each API tool comprised in the training dataset can be represented by a name and a description that can provide/signal the purpose of the API tool to the dense retriever model. During training, the dense retriever model can be primarily trained to utilize a context window comprising two API tools preceding and two API tools succeeding the API tool to be predicted (i.e., the target prediction). Further, the dense retriever model can be trained to predict API tools in a sub-chain even when some API tools are missing. To achieve this, the training component can train the dense retriever model to minimize the embedding distance between the context window and a ground truth action embedding of a positive sample (i.e., a desirable API tool), while maximizing an embedding distance between the context window and challenging negative samples (i.e., undesirable API tools).

Thus, in various embodiments, a PBA or an NBA can be predicted by a tool prediction component based on existing API tools, thereby providing a versatile approach to contextual tool sequencing. In contrast to existing solutions that typically employ user-defined objectives for predicting the next action/tool, embodiments of the present disclosure operate at the tool level, independent of an explicit, well-defined objective. For example, an existing contextual tool sequencing technique that combines reasoning and acting in language models for general task solving relies on a user-defined prompt to guide a model to solve a task. On the contrary, the methods and techniques of the present disclosure can operate without a predefined user objective, predicting tool sequences based solely on context. Another existing contextual tool sequencing technique involves the use of API calls to enhance the ability of large language models (LLMs) to use tools. This techniques relies on accurate input arguments and API call generation. On the contrary, the methods and techniques of the present disclosure can operate at a higher level of abstraction by predicting sequences of API tools without specific user objectives. Yet another existing contextual tool sequencing technique employs a framework for automatic generation of reasoning steps and tool usage in LLMs and relies on task-specific demonstrations and interleaving of model generations with tool use. On the contrary, the methods and techniques of the present disclosure can predict sequences of API tools without relying on hand-crafted demonstrations or a user-defined objective.

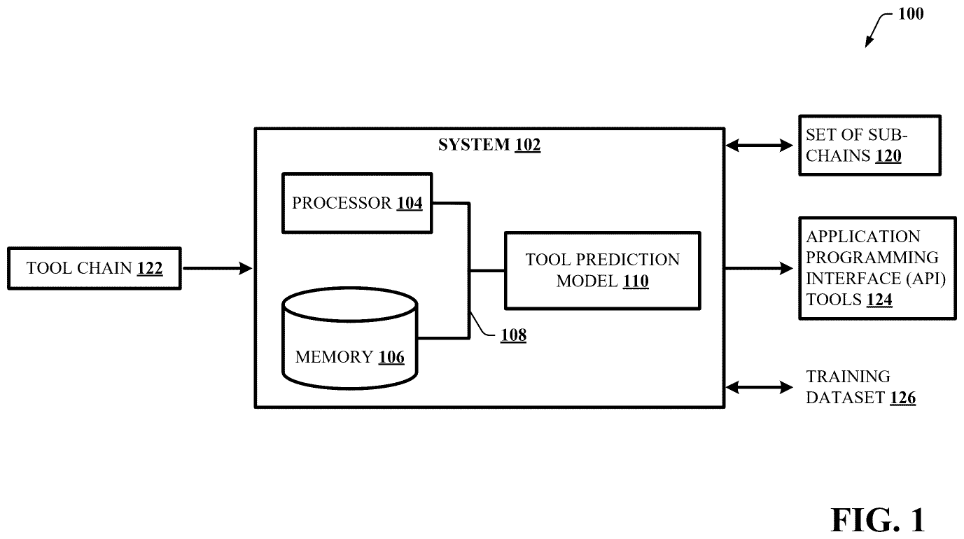

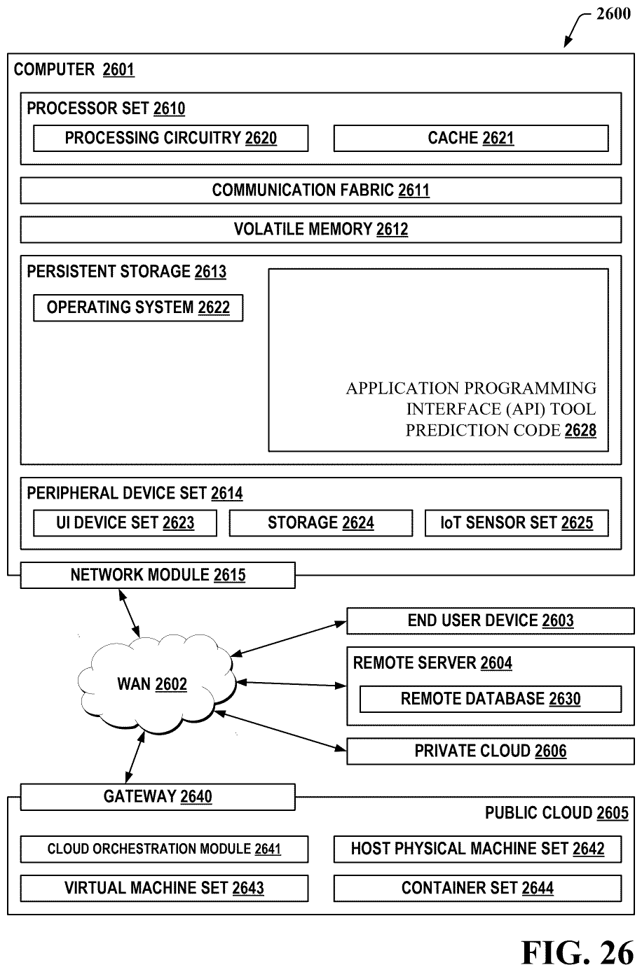

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 2600 illustrated at FIG. 26. For example, non-limiting system 100 can be associated with, such as accessible via, a computing environment 2600 described below with reference to FIG. 26, such that aspects of processing can be distributed between non-limiting system 100 and the computing environment 2600. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that can predict an API tool that can be employed at a defined position within a context window, in accordance with one or more embodiments described herein.

Non-limiting system 100 and/or the components of non-limiting system 100 can be employed to use hardware and/or software to solve problems that are highly technical in nature (e.g., related to API tool prediction based on context awareness, LLMs, etc.), that are not abstract and that cannot be performed as a set of mental acts by a human. Further, some of the processes performed may be performed by specialized computers for carrying out defined tasks related to context-aware predictive tool sequencing. Non-limiting system 100 and/or components of non-limiting system 100 can be employed to solve new problems that arise through advancements in technologies mentioned above and/or the like. Non-limiting system 100 can provide technical improvements to artificial intelligence (AI) systems by improving prediction efficiency and accuracy, reducing prediction time, and/or improving the adaptability and flexibility of AI systems in contextual tool sequencing.

Embodiments of the present disclosure provide a distinctive contribution to the field of contextual tool sequencing by dynamically predicting sequences of API tools based on API tools selected by an entity (e.g., hardware, software, machine, AI, neural network and/or user), without the need for a predefined objective. This approach enhances adaptability, personalization and efficiency of AI models in constructing tailored tool chains.

In various embodiments, non-limiting system 100 can comprise system 102. Discussion turns briefly to processor 104, memory 106 and bus 108 of system 102. For example, in one or more embodiments, system 102 can comprise processor 104 (e.g., computer processing unit, microprocessor, classical processor, and/or like processor). In one or more embodiments, a component associated with system 102, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, system 102 can comprise a computer-readable memory (e.g., memory 106) that can be operably connected to processor 104. Memory 106 can store computer-executable instructions that, upon execution by processor 104, can cause processor 104 and/or one or more other components of system 102 (e.g., tool prediction model 110, sub-chain generation component 202, access component 204, prediction component 206, execution component 208 and/or training component 210) to perform one or more actions. In one or more embodiments, memory 106 can store computer-executable components (e.g., tool prediction model 110, sub-chain generation component 202, access component 204, prediction component 206, execution component 208 and/or training component 210).

System 102 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, system 102 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 102 can reside in the cloud, and/or can reside locally in a local computing environment (e.g., at a specified location(s)).

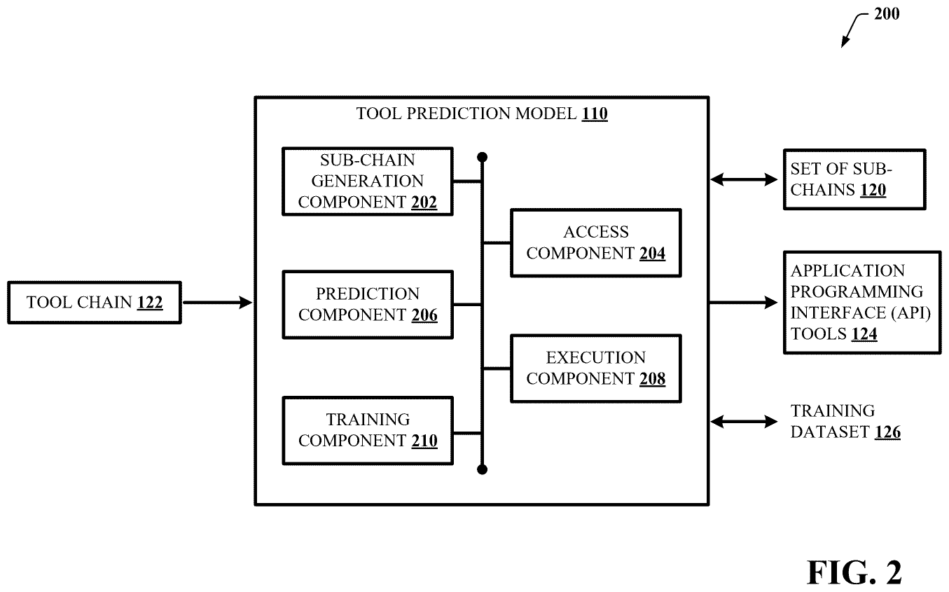

In one or more embodiments, system 102 can further comprise tool prediction model 110. As illustrated in FIG. 2, tool prediction model 110 can comprise sub-chain generation component 202, access component 204, prediction component 206, execution component 208 and/or training component 210. In various embodiments, tool prediction model 110 can predict one or more API tools (e.g., API tools 124) to develop tool chain 122 that can be deployed as a frontend service. For example, tool prediction model 110 can be employed by an application developer at the backend to predict one or more API tools within a tool chain, wherein respective API tools of the one or more API tools can be employed at respective defined positions within the tool chain, and the tool chain can be deployed as a functionality/service within a frontend application or as a frontend application. For example, the tool chain can be a service that can generate a list of hardware tools for home improvement, and the tool chain can be deployed on a hardware store website as an option that can be selected (e.g., via touch, mouse clicks, audio instructions, etc.) by an end entity (e.g., hardware, software, machine, AI, neural network and/or user) to generate the list of hardware tools. In another example, the tool chain can be a car rental option that can be deployed on a travel website to allow the entity to rent cars.

In an embodiment, an API tool predicted by tool prediction model 110 can be presented to the application developer as a recommendation of the next API tool that can be employed within the tool chain being developed. In another embodiment, tool prediction model 110 can automatically insert the predicted API tools within the tool chain to complete the tool chain. In various embodiments, the application developer or another entity (e.g., hardware, software, machine, AI, neural network and/or user) can define the tool chain in advance, and one or more API tools within the tool chain can be reused/repurposed for a different routine/task upon being identified by prediction component 206 as the suitable API tool for that routine/task.

As mentioned earlier, in various embodiments, tool prediction model 110 can predict one or more API tools within a tool chain. For example, in various embodiments, access component 204 can accesses a context window comprising a sequence of API tools. In various embodiments, prediction component 206 can predict an API tool for a defined position within the context window based on a context provided by the sequence of API tools. Each API tool comprised in the context window can be employed to execute an action within the context window. In various embodiments, prediction component 206 can predict the API tool based on only the context defined by other API tools in the context window, that is, without employing a query provided by an entity (e.g., hardware, software, machine, AI, neural network and/or user). For example, the context window can comprise four API tools, wherein two API tools can be visualized as respectively occupying the first and second positions in the context window, and two API tools can be visualized as respectively occupying the fourth and fifth positions in the context window. Based on the context of the four API tools, prediction component 206 can predict a fifth API tool, wherein the fifth API tool can be employed at the third position in the context window. That is, prediction component 206 can employ the first two API tools as a context prefix and the final two API tools as a context suffix, infer an intent or goal of the context window, and predict the API tool for the third position in the context window. The API tools existing in the context window can comprise API tools selected by the entity as part of a backend task and/or API tools previously predicted by prediction component 206. In various embodiments, depending on the location of existing API tools in the context window, the API tool can be predicted by prediction component 206 as a missing PBA and/or NBA. For example, if the API tool is to be predicted for the first position within the context window, prediction component 206 can predict the API tool as a PBA since the API tool would precede the existing API tools in the sequence, whereas if the API tool is to be predicted for the final position within the context window, prediction component 206 can predict the API tool as an NBA since the API tool would be the last API tool in the sequence.

In various embodiments, the context window can represent a sub-chain (i.e., a sub-chain of API tools) within the set of sub-chains 120, and the set of sub-chains 120 can be generated or derived from tool chain 122. For example, in various embodiments, sub-chain generation component 202 can generate the set of sub-chains 120 from tool chain 122 via a sliding window approach with a defined number of stride steps. For example, sub-chain generation component 202 can employ a dynamic approach and construct sub-chains of size N from a tool chain of size M. For example, sub-chain generation component 202 can employ a sliding window with a stride step of one (1), wherein the sliding window can generate the contextual sub-chains that represent a sequence of API tools provided by end entity (e.g., hardware, software, machine, AI, neural network and/or user). For a tool chain [1, 2, 3, 4, 5] of size M=5, sub-chains of size N=3 would be [1, 2, 3], [2, 3, 4], [3, 4, 5], and prediction component 206 can predict/shortlist an optimal API tool at a specific position (e.g., N/2) within each sub-chain N by considering the context of existing API tools surrounding the missing API tool.

In this regard, the API tool predicted by prediction component 206 for the context window can be one of several API tools predicted by prediction component for tool chain 122. For example, in various embodiments, prediction component 206 can predict respective API tools (e.g., API tools 124) for respective sub-chains comprised in the set of sub-chains 120, based on respective contexts of the respective sub-chains, such that predicting the respective API tools for the respective sub-chains can complete tool chain 122. The respective API tools can be employable to execute respective actions within tool chain 122, and multiple tool chains such as tool chain 122 can be developed by predicting the suitable API tools for each tool chain. Thus, in one or more embodiments, tool prediction model 110 can act as an application developer's toolkit that can be employed by an entity to develop software, develop an application, and so on, by creating different API chains. In various embodiment, prediction of API tools by prediction component 206 can comprise recommending or retrieving existing API tools. For example, to predict an API tool, prediction component 206 can access a database of API tools previously employed for developing tool chains, and based on the context relied upon by prediction component 206 to predict the API tool, prediction component 206 can identify and select the most appropriate API tool from the database of API tools.

In various embodiments, prediction component 206 can be an AI model that can be trained by training component 210 to predict API tools 124. To train prediction component 206, training component 210 can generate training dataset 126, wherein training dataset 126 can comprise sub-chains of API tools, contextual information related to the sub-chains of API tools, positive samples and negative samples. Each sub-chain comprised in training dataset 126 can have a predefined goal. Positive samples represent first API tools that can be suitable for the defined position (i.e., suitable as the API tool to be predicted), and negative samples represent second API tools that can be unsuitable for the defined position (i.e., unsuitable as the API tool to be predicted). Further, each API tool comprised in training dataset 126 can be represented by its name and description that can indicate or signal the purpose of the API tool to prediction component 206. Accordingly, in a generic scenario, prediction component 206 can treat an API tool to be predicted for a defined position within a sub-chain (e.g., the middle position N/2 for a sub-chain of size N) as a positive sample that can represent the previous best tool or PBA to be employed for the defined position. To enhance the training process, in one or more embodiments, training component 210 can employ hard negative sampling mechanisms to generate the negative samples that should not be considered as suitable API tools by prediction component 206 for the defined position.

In various embodiments, training component 210 can employ training dataset 126 to train prediction component 206 (i.e., the AI model) to minimize an embedding distance between the context window within which an API tool is to be predicted and a tool embedding of a positive sample, while maximizing the embedding distance to the negative samples. For example, in an embodiment, prediction component 206 can be a dense retriever model that can be employed within a shortlisting algorithm (e.g., tool prediction model 110), and prediction component 206 can be trained by training component 210 to infer an overall objective or end goal of an end entity (e.g., hardware, software, machine, AI, neural network and/or user) based on a context provided by API tools comprised in a context window and/or previously predicted. To achieve this, training component 210 can train the dense retriever model with contrastive loss, wherein the dense retriever model can learn to minimize the distance between the embedding of the context window and a ground truth action (i.e., positive sample) embedding while maximizing the distance between the embedding of the context window from challenging negative samples (i.e., embeddings of challenging negative samples).

In various embodiment, training prediction component 206 by employing training dataset 126 (i.e., sub-chains, contextual information, positive samples and hard negative samples) can enhance an ability of prediction component 206 to infer, based only on the context associated with the sequence of API tools comprised in a context window, a task objective associated with the sequence of API tools. The training can further enhance an understanding of prediction component 206 regarding functionalities of API tools comprised in training dataset 126. For example, during the training, prediction component 206 can develop a profound understanding of API tool functionalities and relationships by leveraging the enriched context, including details such as an API tool's name, description, input parameters and output parameters. The heightened comprehension can enable prediction component 206, and thereby tool prediction model 110, to predict the PBA and/or NBA to be employed at a defined position within a sequence of API tools comprised in a context window (i.e., sub-chain). The deliberate adaptability that can be imparted to prediction component 206 upon training can accommodate diverse scenarios and ensure that prediction component 206 can infer an entity's objective even when the objective is not explicitly stated. For example, the adaptability of prediction component 206 with focus on a sub-chain with a maximum length of N, wherein N represents a positive integer, can ensure robust predictions across a spectrum of sequential scenarios. This can enhance the contribution of tool prediction model 110 to sequential tasks.

In various embodiments, execution component 208 can execute the API tool predicted by prediction component 206 for the defined position within the context window, wherein execution of the API tool can generate an outcome, and wherein the outcome can be accessible as input data by a subsequent API tool in the sequence of API tools. For example, recall that tool chain 122 can represent a functionality/service within a frontend application or a frontend application. In one or more embodiments, once the API tools missing from tool chain 122 have been predicted by prediction component 206 and tool chain 122 has been completed, tool chain 122 can be deployed as part of a frontend functionality. The frontend functionality can be accessed by an end entity (e.g., hardware, software, machine, AI, neural network and/or user) via a user interface (UI) at a device (e.g., desktop computer, laptop, smartphone, tablet, etc.), in response to which, execution component 208 can begin executing tool chain 122 by sequentially executing the API tools comprised in tool chain 122. Each API tool within tool chain 122 can produce an outcome or data that can be employed by a subsequent API tool, and the process can continue until tool chain 122 has been completely executed to generate an end result for the end entity. Further, each API tool within tool chain 122 can have access to databases internal to or external to system 102, and upon execution by execution component 208, an API tool can access the suitable database to generate an outcome. For example, tool chain 122 can be executable to generate a list of notable comedy film directors of a certain decade, and one of the API tools within tool chain 122 can be executable to access a film website to identify the most popular comedy films made during that decade. In a different example, tool chain 122 can be executable to generate a list of five start hotels within a city, and an API tool within tool chain 122 can be executable to identify hotel ratings for different hotels within the city.

In summary, the various embodiments described herein can predict optimal sequences of API tools in a dynamic context by predicting one or more API tools as PBAs or NBAs. Entities (e.g., hardware, software, machines, AI, neural networks and/or users) often engage in sequential tasks such as planning a vacation, creating recipes, etc. that involve the strategic selection and arrangement of various API tools. The various embodiments described herein can enhance this experience by predicting an optimal PBA/NBA within a sub-chain of API tools based on the context provided by API tools already existing within the sub-chain. For example, as stated elsewhere herein, prediction component 206 can attempt to infer/speculate an overall objective of an entity (e.g., hardware, software, machine, AI, neural network and/or user) based on the context provided by the existing API tools without being explicitly provided a defined objective of the entity. This is especially advantageous when a query is not available to infer the objective from.

In addressing the broader challenge of contextual tool sequencing, the various embodiments described herein can empower entities to seamlessly construct efficient tool chains without employing pre-defined objectives. For example, consider a scenario where an entity is engaged in developing a service for planning various activities during a vacation, wherein such planning can involve multiple different API tools. The entity can select API tools to plan itineraries, check weather, search for restaurants, and so on, and the selected API tools can provide a specific context. Prediction component 206 can adapt to the specific context and predict the NBA that the entity can employ as one of the API tools for the service. Unlike existing solutions that often rely on predetermined sequences of API tools or lack adaptability to entity-specific contexts, the various embodiments herein can dynamically predict API tool sequences based on the context of existing API tools. That is, the various embodiments herein can dynamically respond to an entity's evolving preferences and contextual needs. The tendency of existing solutions to rely on explicitly defined task objectives for contextual sequencing tasks can limit their adaptability. For example, such existing solutions cannot adapt to varied user preferences and unique contextual scenarios.

FIG. 2 illustrates a block diagram of an example, non-limiting system 200 that can predict an API tool that can be employed at a defined position within a context window, in accordance with one or more embodiments described herein. Repetitive description of like elements and/or processes employed in respective embodiments is omitted for sake of brevity.

Non-limiting system 200 illustrates the system of tool prediction model 110. As described with reference to FIG. 1, tool prediction model 110 can comprise sub-chain generation component 202, access component 204, prediction component 206, execution component 208 and/or training component 210. In one or more embodiments, tool prediction model 110 can be a shortlisting algorithm that can efficiently narrow the search space for API tools from potentially thousands or tens of thousands of API tools to just tens or hundreds by employing a dense retriever model (e.g., prediction component 206).

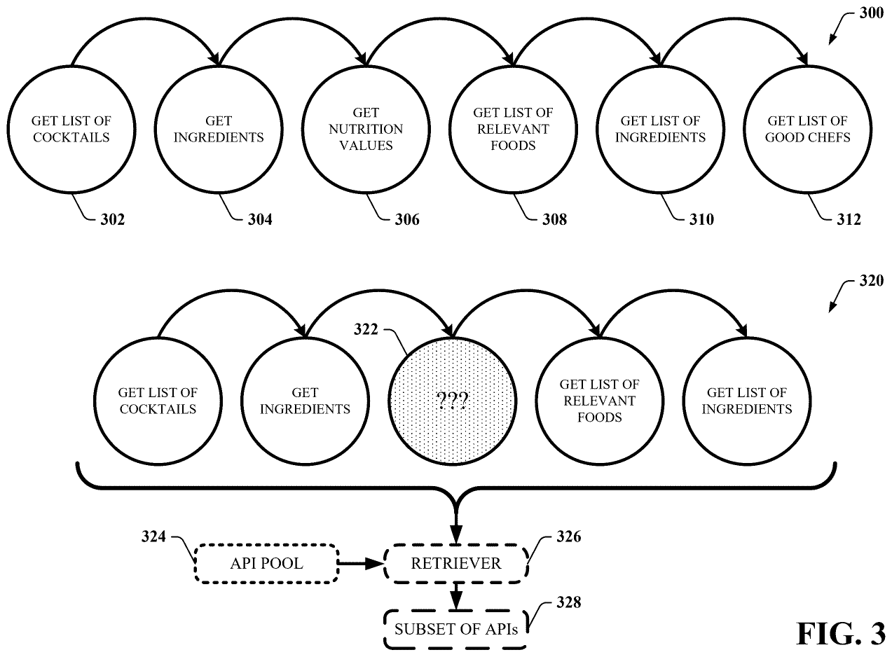

FIG. 3 illustrates diagrams of an example, non-limiting tool chain 300 and an example, non-limiting method 320 that can predict one or more API tools within the tool chain via a PBA approach, in accordance with one or more embodiments described herein. Repetitive description of like elements and/or processes employed in respective embodiments is omitted for sake of brevity.

Non-limiting tool chain 300 illustrates an example of tool chain 122 (TooLLM API chain), wherein the individual API tools can be related to a tool named ‘Nutrition’ within the ‘Food’ category, and wherein non-limiting tool chain 300 can be executable to determine how a cocktail can be prepared. The API tools in non-limiting tool chain 300 can comprise API tools 302-312, wherein each API tool can execute an action. For example, API tool 302 can retrieve a list of cocktails, API tool 304 can retrieve ingredients, API tool 306 can retrieve nutrition values (e.g., for each ingredient retrieved by API tool 304), API tool 308 can retrieve a list of relevant foods, API tool 301 can retrieve a list of ingredients (e.g., for the relevant foods), and API tool 312 can retrieve a list of good chefs. In other words, when non-limiting tool chain 300 is executed, the individual API tools are sequentially executed, and each API tool can generate an outcome that can be employed by the next API tool in the sequence.

As described with reference to FIGS. 1 and 2, tool prediction model 110 can predict one or more API tools within non-limiting tool chain 300 to complete non-limiting tool chain 300, wherein an API tool can be predicted as a PBA or an NBA. This is further illustrated by non-limiting method 320. For example, consider the sub-chain of API tools 302-310 illustrated as part of non-limiting method 320. The sub-chain can be generated by sub-chain generation component 202 from non-limiting tool chain 300 via a sliding window approach, and the sub-chain can initially comprise a missing API tool at position 322. Recall that tool prediction model 110 can be a shortlisting algorithm. Given the sub-chain of API tools 302-310, tool prediction model 110 can predict API tool 306 for position 322 by employing a shortlisting mechanism capable of identifying a reduced set of API tools (e.g., skills) from API pool 324, wherein API pool 324 can comprise multiple existing API tools.

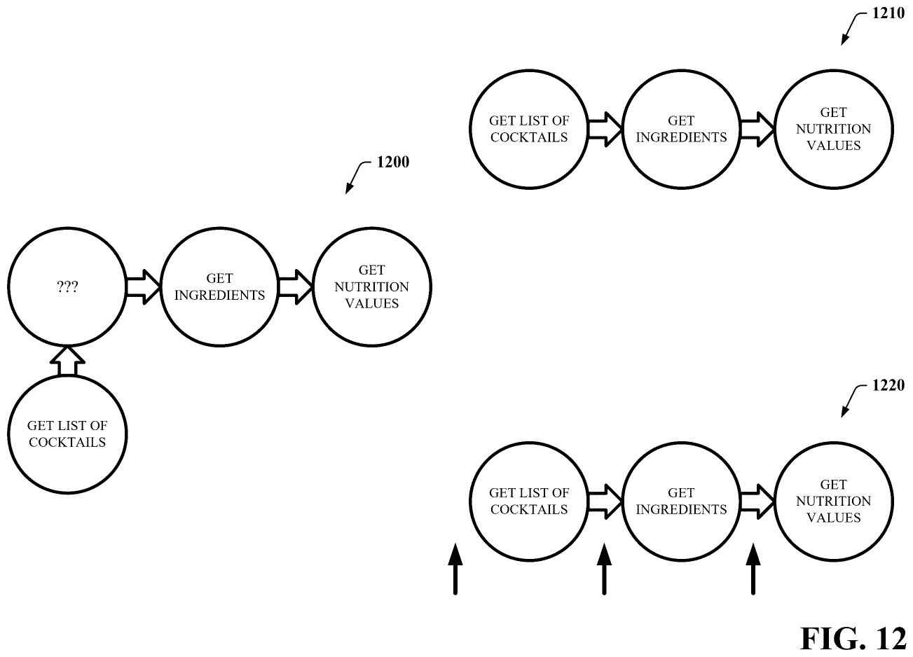

In one or more embodiments, the shortlisting mechanism of tool prediction model 110 can be enabled by a Previous Best Action (PBA) algorithm that can identify a more manageable subset of API tools/skills/actions. The PBA algorithm can be provided by prediction component 206. For example, recall further that in one or more embodiments, prediction component 206 can be a dense retriever model (illustrated as retriever 326 in FIG. 3) that can be trained by training component 210 (similar to the Word2Vec algorithm) to predict API tools within a tool chain as PBAs or NBAs. For example, given the context window (i.e., the sub-chain) of API tools 302-310 comprising two API tools prior to and two API tools after position 322, the dense retriever model can aim to retrieve from API pool 324, subset of APIs 328 comprising the top KAPI tools that best fit the intermediate position (e.g., position 322) within the context window. Upon retrieving the subset of APIs 328, the dense retriever model can further predict, by minimizing the distance between the context window and positive samples comprised in the subset of APIs 328, that API tool 306 is the most suitable API tool for position 322. In this regard, in one or more embodiments, the dense retriever model can employ the PBA algorithm to predict an API tool. The PBA algorithm has been discussed in greater detail with reference to FIG. 12. It should be appreciated that the PBA algorithm can predict an API tool as a PBA and/or an NBA.

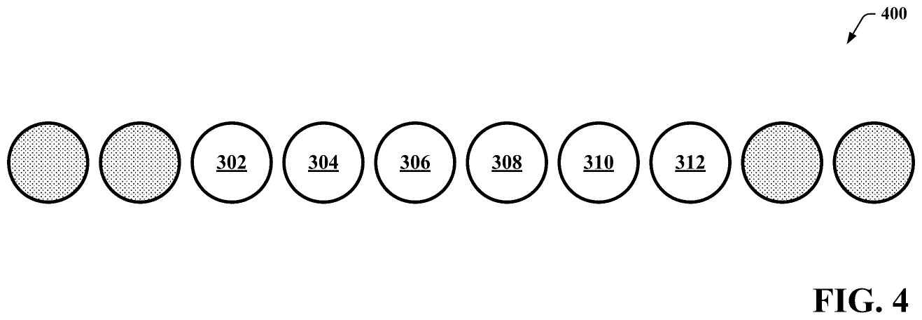

FIG. 4 illustrates a diagram of an example, non-limiting tool chain 400 of API tools that can be employed to generate a training dataset to train an algorithm to predict an API tool within a sub-chain of API tools, in accordance with one or more embodiments described herein. Repetitive description of like elements and/or processes employed in respective embodiments is omitted for sake of brevity.

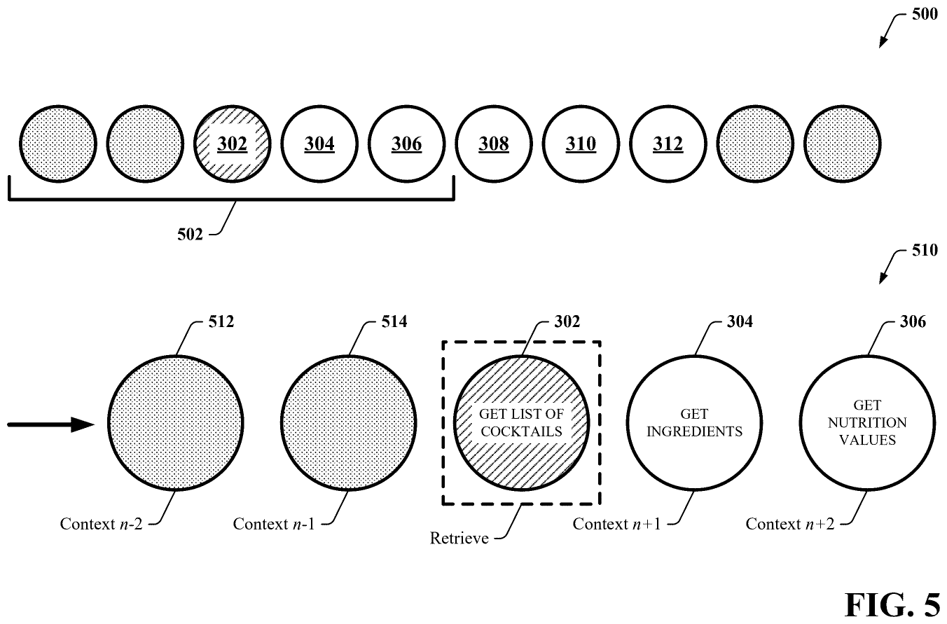

Non-limiting tool chain 400 can represent an exemplary tool chain comprised in training dataset 126, and non-limiting tool chain 400 can comprise the same API tools as those illustrated by non-limiting tool chain 300. As previously described, training dataset 126 can be generated by training component 210 to train prediction component 206, wherein training dataset 126 can comprise sub-chains of API tools, contextual information related to the sub-chains of API tools, positive samples (i.e., suitable API tools) and negative samples (i.e., unsuitable API tools). In an embodiment, the sub-chains of API tools comprised in training dataset 126 can be sub-chains generated by sub-chain generation component 202 as part of prior API tool prediction tasks executed by tool prediction model 110. In another embodiment, the sub-chains of API tools comprised in training dataset 126 can be specially generated by sub-chain generation component 202 to generate training dataset 126. FIGS. 5-11 further illustrate how non-limiting tool chain 400 can be employed to generate training dataset 126 and to train prediction component 206.

FIGS. 5-11 illustrate diagrams of example, non-limiting steps associated with training an algorithm to predict an API tool within a sub-chain of API tools, in accordance with one or more embodiments described herein. Repetitive description of like elements and/or processes employed in respective embodiments is omitted for sake of brevity.

As previously discussed, training dataset 126 can be generated from tool chains of API tools. For example, in an embodiment, training component 210 can engage/employ sub-chain generation component 202 to generate training dataset 126 from non-limiting tool chain 400. Sub-chain generation component 202 can apply a sliding window approach with a stride step of 1 (k=1) to non-limiting tool chain 400 to generate sub-chains with size N=5. For each position in a sub-chain thus generated, the first two API tools and the last two API tools can provide the context associated with the task that the sub-chain is directed to, such that the API tool in the central position can be considered as the ground truth API tool that prediction component 206 can be trained to predict and retrieve. To illustrate how each API tool in a sub-chain can be viewed by prediction component 206, beginning at the left-hand side of the context windows illustrated in each of FIGS. 5-9 and 10, the first API tool is labeled Context n−2, the second API tool is labeled Context n−1, the third API tool is labeled Retrieve, the fourth API tool is labeled Context n+1 and the fifth API tool is labeled Context n+2, wherein Context n−2/n+2 can indicate the context of the second API tools from the API tool to be retrieved, and Context n−1/n+1 can indicate the context of the first API tools from the central API tool. In some scenarios, an API tool in any position other than the central position within a sub-chain can be considered the ground truth API tool. During training on training dataset 126, prediction component 206 can learn to predict the ground truth API tool. Thus, prediction component 206 can be trained for various scenarios.

For example, at non-limiting step 500 of FIG. 5, sub-chain generation component 202 can generate sub-chain 502 from non-limiting tool chain 400 as part of generating training dataset 126. Sub-chain 502 can represent a sparse context window wherein the ground truth API tool to be predicted is the first API tool instead of being the central API tool, and no API tools exist prior to the ground truth API tool. In FIG. 5, the empty positions within sub-chain 502 are identified by numerals 512 and 514. At non-limiting step 510, training component 210 can train prediction component 206 to predict API tool 302 by employing API tools 304 and 306 to infer the context of sub-chain 502. For example, prediction component 206 can be trained to predict an API tool that can retrieve a list of cocktails.

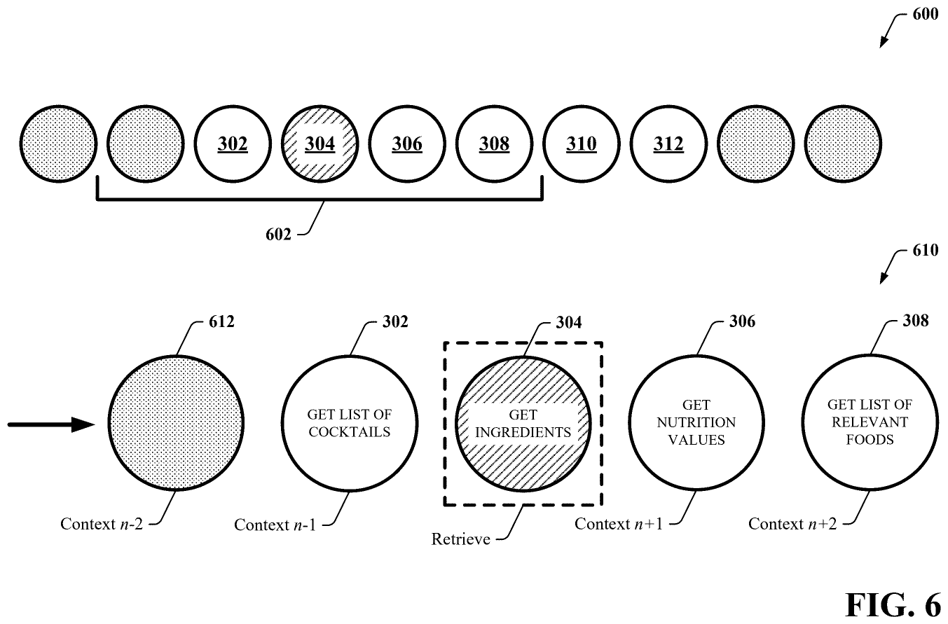

Similarly, at non-limiting step 600 of FIG. 6, sub-chain generation component 202 can generate sub-chain 602 from non-limiting tool chain 400 as part of generating training dataset 126. Non-limiting step 600 represents a step forward from non-limiting step 500. In FIG. 6, the empty position within sub-chain 602 is identified by numeral 612. At non-limiting step 610, training component 210 can train prediction component 206 to predict API tool 304 by employing API tools 302, 306 and 308 to infer the context of sub-chain 602. For example, prediction component 206 can be trained to predict an API tool that can retrieve ingredients for cocktails.

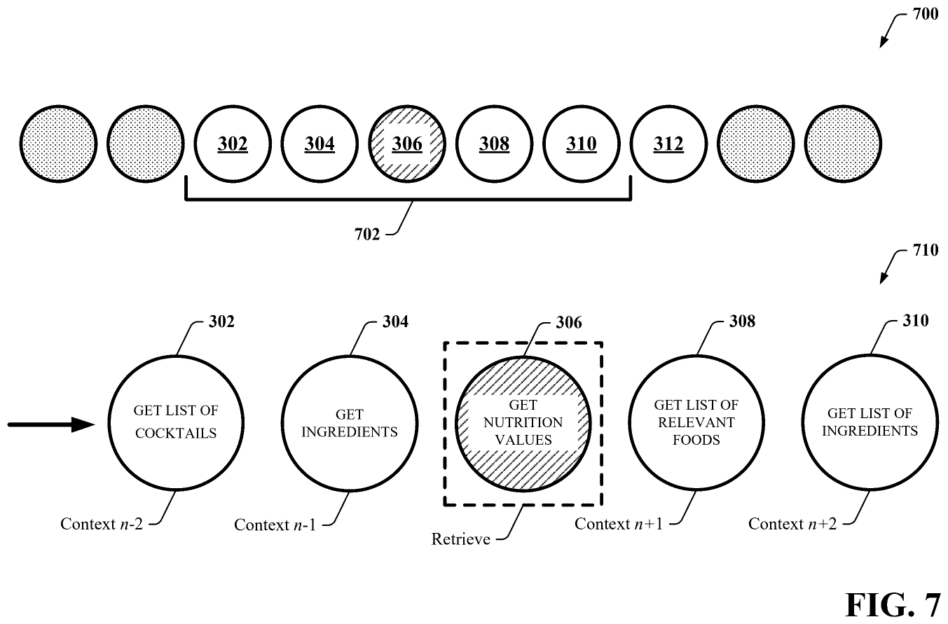

A similar procedure is illustrated in FIG. 7, wherein at non-limiting step 700, sub-chain generation component 202 can generate sub-chain 702, and at non-limiting step 710, training component 210 can train prediction component 206 to predict API tool 306 by employing API tools 302, 304, 308 and 310 to infer the context of sub-chain 702. For example, prediction component 206 can be trained to predict an API tool that can retrieve nutrition values for different cocktail ingredients.

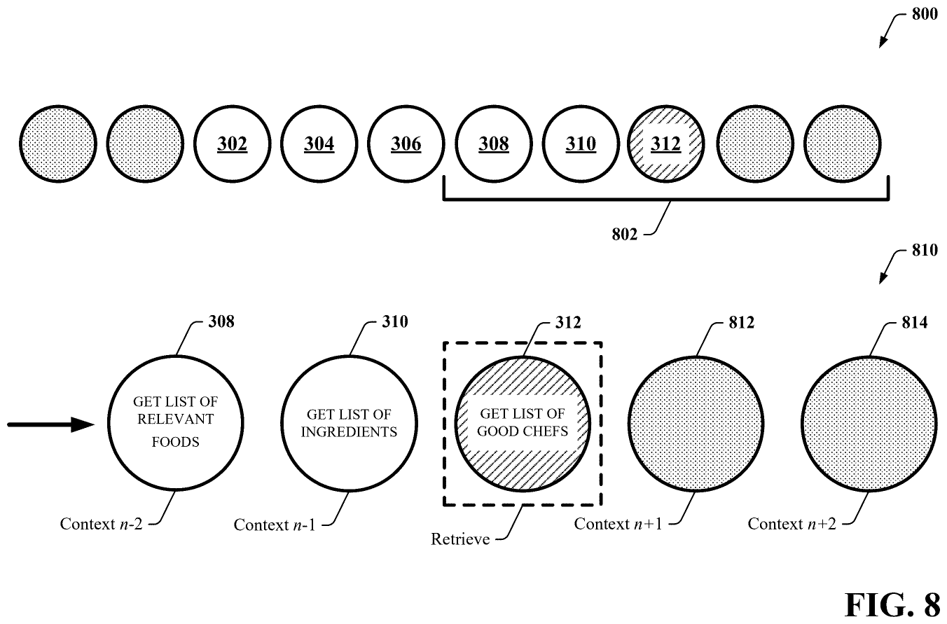

FIG. 8 illustrates the final step of employing non-limiting tool chain 400 to generate training dataset 126 and employing training dataset 126 to train prediction component 206. For example, at non-limiting step 800, sub-chain generation component 202 can generate sub-chain 802, and at non-limiting step 810, training component 210 can train prediction component 206 to predict API tool 312 by employing API tools 308 and 310 to infer the context of sub-chain 802. For example, prediction component 206 can be trained to predict an API tool that can retrieve a list of good chefs. In FIG. 8, the empty positions within sub-chain 802 are identified by numerals 812 and 814. Similar to sub-chain 502, sub-chain 802 can represent a sparse context window, wherein API tool 312 can be predicted based only on two preceding API tools because no API tools exist at positions 812 and 814.

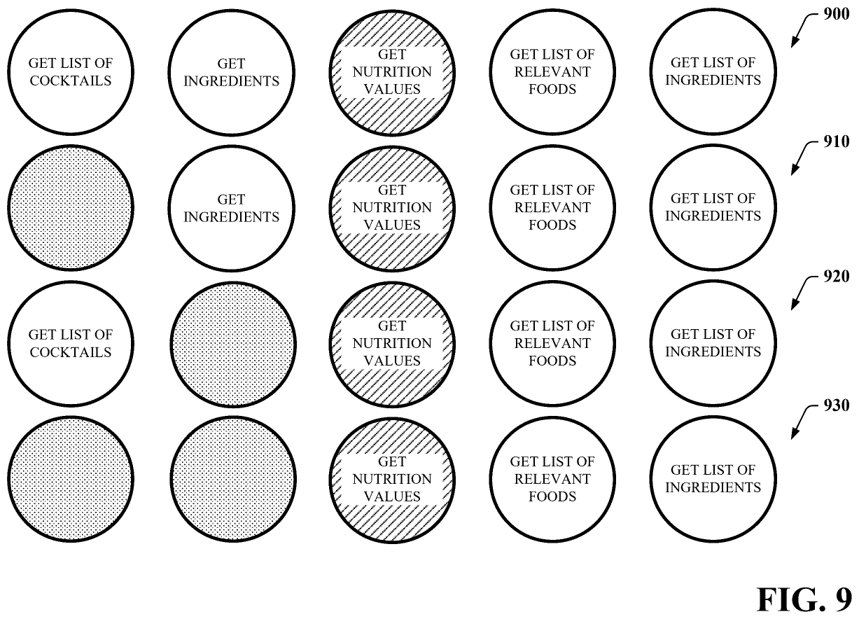

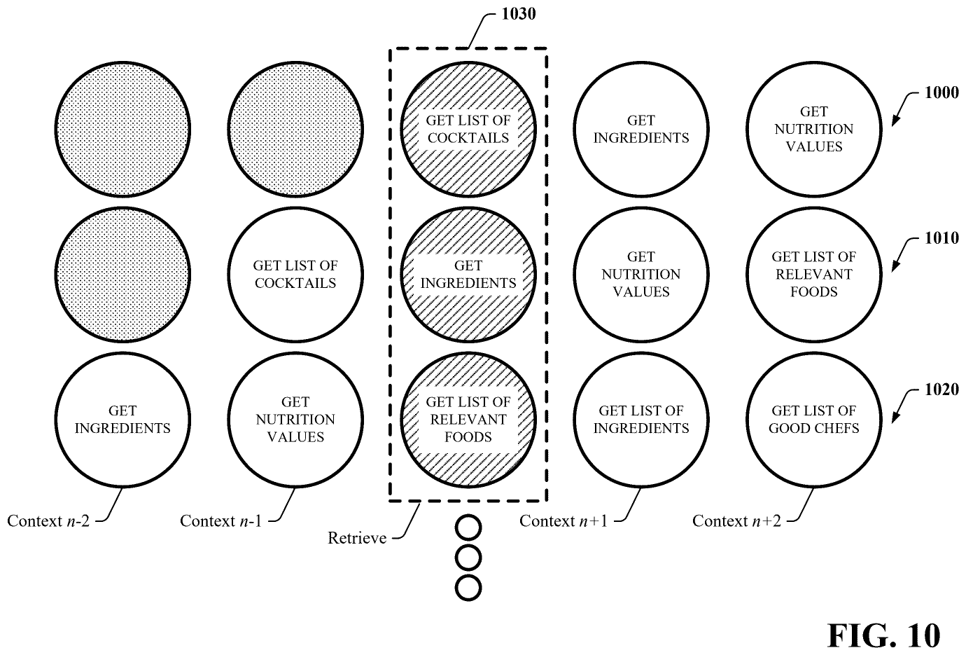

As discussed elsewhere herein, by employing sparse context windows in training dataset 126, prediction component 206 can be trained to retrieve relevant API tools in various scenarios, including scenarios where some context is missing. This is further illustrated in FIGS. 9 and 10. In FIG. 9, each of non-limiting steps 900, 910, 920 and 930 illustrate different respective scenarios where prediction component 206 can be trained to predict API tool 306 at the central position within a sub-chain based on two previous and two subsequent API tools, or when some API tools are missing from the sub-chain. For example, in some embodiments, training component 210 can mask some of the API tools within sub-chains to generate different notations and permutations of training dataset 126. Similarly, in FIG. 10, each of non-limiting steps 1000, 1010 and 1020 illustrate different respective scenarios wherein prediction component 206 can predict an API tool at the central position (indicated by column 1030) within each sub-chain, even when the sub-chain represents a sparse context window. In general, by training prediction component 206 with contrastive loss wherein an embedding space/embedding distance of a context window to hard negative samples is enlarged, and an embedding space/embedding distance of the context window to positive samples is reduced, prediction component 206 can be trained to predict missing API tools.

API tool 312 can be the final API tool in non-limiting tool chain 400. It should be noted that non-limiting steps 500, 510, 600, 610, 700, 710, 800 and 810 are illustrated as individual steps to show how each sub-chain comprised in training dataset 126 can be employed by training component 210 as a different context to train prediction component 206. In practice, each of sub-chains 502, 602, 702 and 802 can be generated by sub-chain generation component 202 as part of a single step or multiple consecutive steps. Training component 210 can employ such sub-chains to generate training dataset 126. Additionally, multiple tool chains such as non-limiting tool chain 400 can be employed to generate training dataset 126. Upon generation of training dataset 126, training component 210 can execute non-limiting steps 510, 610, 710 and 810 as consecutive training steps to train prediction component 206. In general, the subject innovation is not limited by the acts illustrated and/or by the order of acts, for example acts can occur in one or more orders and/or concurrently, and with other acts not presented and described herein.

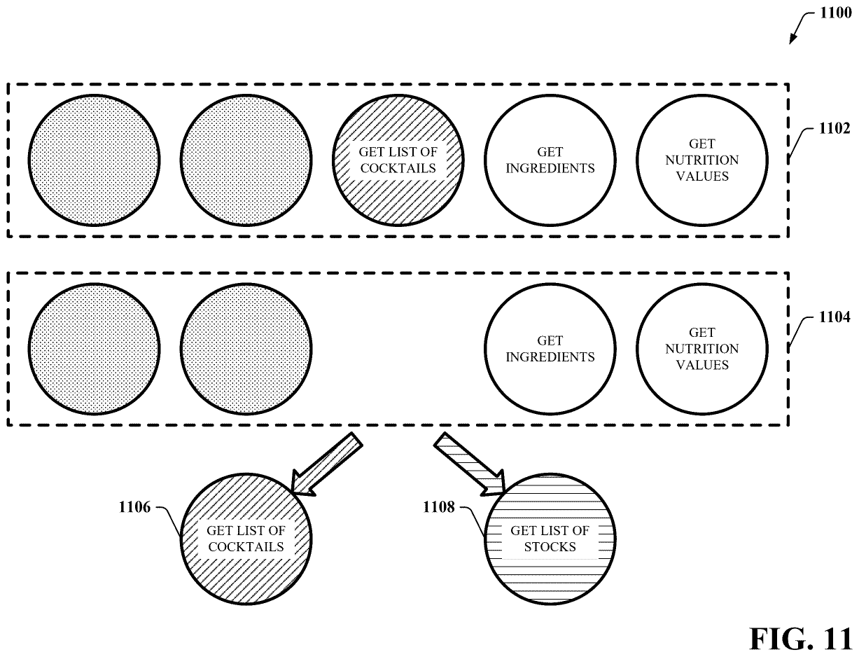

The training procedure corresponding to non-limiting steps 510, 610, 710 and 810 is described in greater detail with reference to non-limiting step 1100 of FIG. 11. In various embodiments, training component 210 can train prediction component 206 (e.g., a dense retriever model) to process each sub-chain generated from a tool chain by utilizing an encoding model. As a result, prediction component 206 can learn to minimize the embedding distance between a context window embedding corresponding to a sub-chain and the ground truth API tool embedding, that is, the embedding of the ground truth API tool positioned in the middle of the sub-chain, while simultaneously maximizing the embedding distance between the context window embedding and a hard negative sample embedding (i.e., hard negative API tool embedding) sampled from an API pool (e.g., API pool 324). For example, at non-limiting step 510, prediction component 206 can learn to minimize the embedding distance between the context window embedding corresponding to sub-chain 502 and the ground truth API embedding of API tool 302, while maximizing the embedding distance between the context window embedding and a hard negative sample embedding. As described elsewhere herein, in one or more embodiments, training component 210 can employ hard negative sampling mechanisms to generate the negative samples comprised in training dataset 126.

Consider, for example, sub-chain 1102 of non-limiting step 1100, wherein sub-chain 1102 can be analogous to sub-chain 502 of FIG. 5, and wherein the central API tool can be the ground truth API tool. Sub-chain 1104 illustrates sub-chain 1102 without the ground truth API tool. In various embodiments, training component 210 can train prediction component 206 to predict the ground truth API tool, wherein the ground truth API tool can be selected from an API pool. API tools 1106 and 1108 illustrate potential API tools that can be selected from the API pool. API tool 1106 can represent a positive sample that can retrieve a list of cocktails, whereas API tool 1108 can represent a negative sample that can retrieve a list of stocks. During training, prediction component 206 can be trained, based on the context provided by the existing API tools in sub-chain 1104, to minimize or reduce the embedding distance between the context window embedding of sub-chain 1102 and the embedding of API tool 1106 while maximizing or enlarging the embedding distance between the context window embedding of sub-chain 1102 and the embedding of API tool 1108.

Consequently, during inferencing upon deployment, prediction component 206 can compare the context window embedding corresponding to a sub-chain against all existing API tools comprised in an API pool such as API pool 324 of FIG. 3. Based on the comparison, prediction component 206 can select the top KAPI tools representing the most suitable API tools to be predicted for a defined position within the sub-chain. The top K API tools can comprise API tools whose respective distances to the context window embedding corresponding to a sub-chain are less than a defined threshold. In an embodiment, the defined threshold can be defined by an entity (e.g., hardware, software, machine, AI, neural network and/or user), whereas in another embodiments, the defined threshold can be determined by prediction component 206 based on the training and prior predictions. Prediction component 206 can further predict the best API tool for the defined position within the sub-chain. For example, prediction component 206 can select from the top K API tools, the API tool with the smallest distance to the context window embedding as the best API tool.

FIG. 12 illustrates flow diagrams of example, non-limiting steps 1200, 1210 and 1220 that can be employed by an algorithm to predict an API tool within a sub-chain of API tools, in accordance with one or more embodiments described herein. Repetitive description of like elements and/or processes employed in respective embodiments is omitted for sake of brevity.

With continued reference to at least FIG. 3, recall that in one or more embodiments, the shortlisting mechanism of tool prediction model 110 can be enabled by a PBA algorithm that can identify a more manageable subset of API tools. Further, in various embodiments, the PBA algorithm can be employed by prediction component 206 that can be a dense retriever model. In this regard, non-limiting steps 1200-1220 illustrate additional aspects of the PBA algorithm.

The API tool prediction approach discussed in various embodiments herein is focused on the PBA algorithm, wherein the PBA algorithm can be directed to finding/predicting from a closed set of pre-defined API tools (e.g., an API pool), a PBA (i.e., an API tool), given an existing sequence of API tools. For example, as illustrated by non-limiting steps 1200, 1210 and 1220, the PBA algorithm can predict an API tool that can retrieve a list of cocktails as a PBA in a sequence of two API tools, wherein one API tool can retrieve ingredients, and another can retrieve nutrition values. The PBA algorithm can aid an entity (e.g., hardware, software, machine, AI, neural network and/or user) in constructing tool chains such as non-limiting tool chain 300 by suggesting appropriate API tools based on actions that can be performed by different API tools. The PBA algorithm can do this by assessing the overall objective of the entity without being explicitly provided with one.

In various embodiments, the PBA algorithm can generate a subset of API tools, given a sequence of API tools (such as in a sub-chain generated by sub-chain generation component 202), and based on the subset of API tools, the PBA algorithm can generate a suitable recommendation for an API tool for a defined position within the sub-chain. In various embodiments, the PBA algorithm can generate a recommendation for each possible location within a tool chain in a single shot/single execution, which can be a time efficient process.

The API tool prediction approach discussed in various embodiments herein can assist the PBA algorithm in the process by shortlisting the set of pre-defined API tools into a much smaller and more concrete subset of API tools (e.g., subset of APIs 328) so that the PBA algorithm can find a suitable candidate from the subset of API tools. As previously stated, in one or more embodiments, the shortlisting mechanism of tool prediction model 110 enabled by the PBA algorithm provided by prediction component 206 can be applied to every possible location within a tool chain, as illustrated by the upward pointing arrows in non-limiting step 1220 that indicate all potential locations within a sub-chain wherein the PBA algorithm can be applied. Further, the PBA can be simultaneously applied to potential locations within a tool chain to enhance the overall efficiency of the API tool prediction approach.

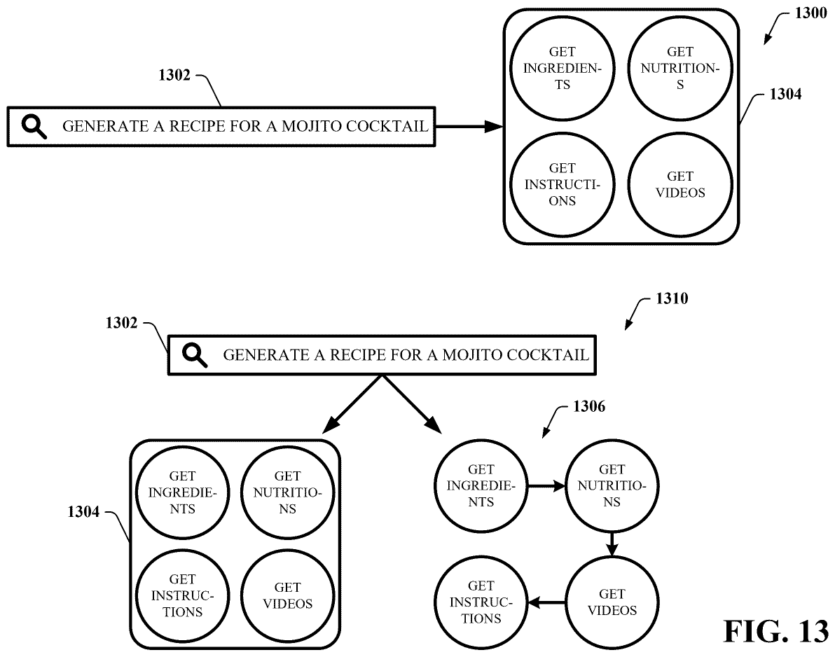

FIG. 13 illustrates flow diagrams of example, non-limiting methods 1300 and 1310 that can retrieve the best API tools for a sequence given a query, in accordance with one or more embodiments described herein. Repetitive description of like elements and/or processes employed in respective embodiments is omitted for sake of brevity.

Similarly to the PBA algorithm, in one or more embodiments, a Natural Language to Sequence (NL2Seq) approach can be employed to predict/retrieve API tools. The NL2Seq approach can access an explicit utterance generated by an entity (e.g., hardware, software, machine, AI, neural network and/or user) and return a subset of relevant APIs aiming to fulfill the objective of the entity, based on the utterance. However, the NL2Seq approach can aim to retrieve the best API tools for a tool chain given a query provided by an entity (e.g., hardware, software, machine, AI, neural network and/or user). For example, in non-limiting method 1300, the NL2Seq approach can retrieve API tools representative of the actions illustrated in block 1304, given query 1302. The two notable differences between the NL2Seq approach and the PBA algorithm are that the NL2Seq approach predicts an API tool based on an input comprising a query (e.g., a user query) in natural language, and the NL2Seq approach can be employed to retrieve the best API tools for an entire sequence of API tools.

In one or more embodiments, the NL2Seq approach can retrieve top-k API tools in one or two ways—in advance or iteratively. For example, as illustrated by non-limiting method 1310, in an embodiment, the NL2Seq approach can predict the top-k API tools in advance (block 1304), given query 1302. In another embodiment, as further illustrated by non-limiting method 1310 at block 1306, assuming that a large language model (LLM) can be employed in the prediction loop/sequence, wherein the LLM can predict the next API tool (i.e., generate the next action) based on the top-k API tools, an API tool can be sequentially predicted as an NBA.

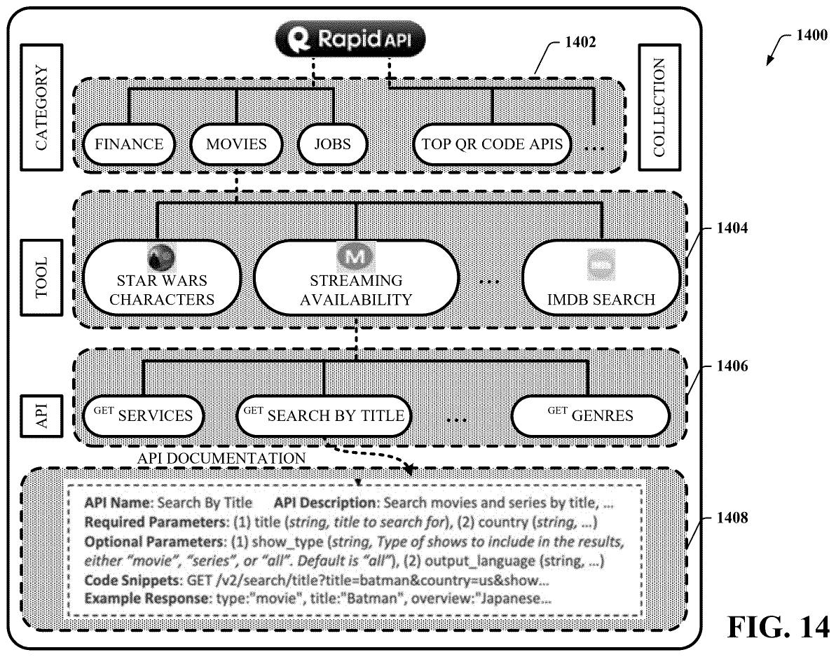

FIG. 14 illustrates a block diagram of an example, non-limiting API platform 1400.

Non-limiting API platform 1400 can be employed to generate a dataset such as training dataset 126.

Discussion turns once again to training dataset 126 (FIGS. 1 and 2) that can be employed in various embodiments to train prediction component 206, as described with reference to at least FIGS. 1, 2 and 5-11. In various embodiments, training component 210 can employ training dataset 126 to train prediction component 206, wherein training dataset 126 can comprise sub-chains of API tools. Ideally, prediction component 206 (e.g., a dense retriever model) and thereby, tool prediction model 110 (e.g., a shortlisting algorithm), can be trained on a collection of such sub-chains. However, high quality such-chains suitable for training are not always readily available. As a result, a dataset was experimentally generated for practical use, in the context of the embodiments of the present disclosure, by employing the Falcon 180 billion (Falcon 180B) LLM from the Rapid® API platform. Non-limiting API platform 1400 illustrates a representation of the Rapid® API platform which comprises a large collection of API tools, divided into categories, as illustrated by block 1402 showing API tools corresponding to finance, movies, jobs, and other domains. Further, each category of API tools can comprise different API tools. For example, as illustrated at block 1404, the movies category can comprise API tools related to Star Wars® characters, Internet Movie Database (IMDb®) search related API tools, etc. Finally, each API tool in a category can be associated with a list of all supported API tools. For example, as illustrated at block 1406, the streaming availability tool corresponding to the movies category can comprise several API tools such as Get Services, Get search by title, etc. An exemplary description of the Get search by title API tool is illustrated at block 1408.

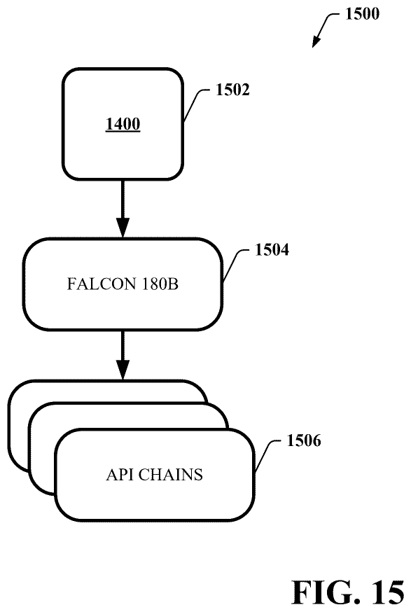

FIG. 15 illustrates a flow diagram of an example, non-limiting method 1500 that can employ the API platform illustrated in FIG. 14 to generate a training dataset, in accordance with one or more embodiments described herein. Repetitive description of like elements and/or processes employed in respective embodiments is omitted for sake of brevity.

Within the Rapid® API platform, different API tools are documented with their API names, descriptions, inputs parameters, output parameters, etc. In one or more embodiments, the Rapid® API platform can be employed to generate training dataset 126. For example, at 1502 of non-limiting method 1500, the Rapid® API platform can be employed to create tool chains of API tools that can be employed to generate training dataset 126. At 1504 of non-limiting method 1500, the Falcon 180B LLM can be provided with various APIs of API tools from the Rapid® API platform and queries to generate logical tool chains of API tools, such that the tool chains can satisfy a logical objective generated by the Falcon 180B LLM. The overall product is a large pool of tool chains of API tools, wherein each tool chain can correspond to a subset of APIs from a specific API tool. For example, at 1506 of non-limiting method 1500, the Falcon 180B LLM can generate API chains representing tool chains of API tools.

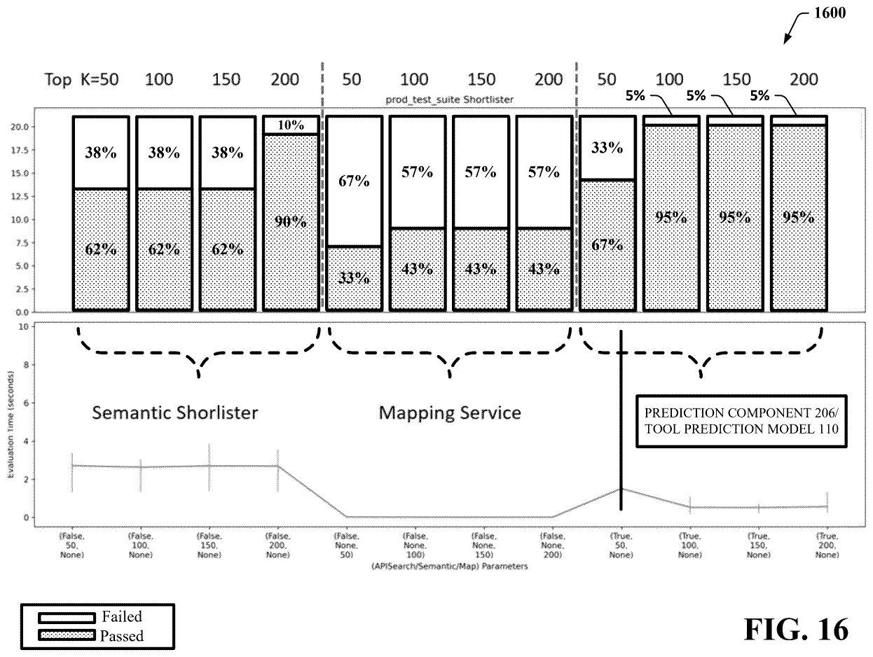

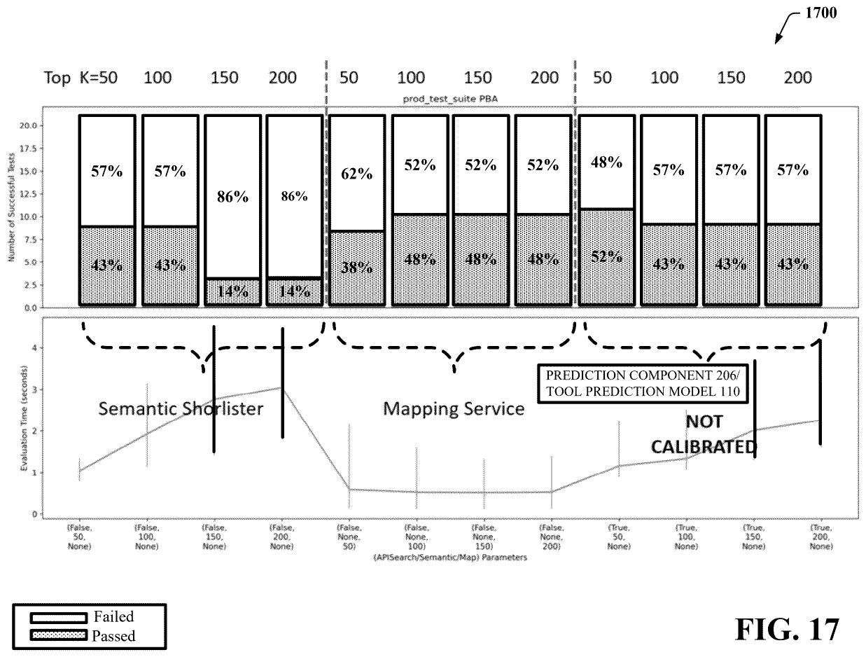

FIGS. 16 and 17 illustrate example, non-limiting graphs 1600 and 1700, respectively, that show the results of evaluating the performance of an algorithm trained to predict an API tool within a sub-chain of API tools, in accordance with one or more embodiments described herein. Repetitive description of like elements and/or processes employed in respective embodiments is omitted for sake of brevity.

To assess the performance of prediction component 206 and thereby, tool prediction model 110, a sequence-benchmarking repository designed to evaluate different shortlister algorithms on various existing datasets of tool chains of API tools was leveraged, wherein the tool chains were imitations of real-world tool chains employed by entities (e.g., hardware, software, machine, AI, neural network and/or user). The experimental evaluation was performed on the datasets of tool chains to determine whether prediction component 206 could generalize well to real-world production-like tool chains. In the experiments thus performed, a semantic shortlister was evaluated, wherein the semantic shortlister can employ input and output parameters of API tools to match API tools like pieces of a puzzle. A second model was also tested, wherein the second model was a unified model, a variant of the IBM® Granite 20 billion model. Finally, the Bidirectional Encoder Representations from Transformers (BERT)-based all-miniLM-L6 model and the Roberta-based IBM® Slate 30 million model were individually evaluated as prediction component 206. Both the BERT-based all-miniLM-L6 model, and the Roberta-based IBM® Slate 30 million model had the same size and were trained by employing the sub-chain-based (i.e., context window-based) training procedure described in one or more embodiments herein on tool chains generated via the Falcon 180B LLM. Each shortlisting algorithm was tested across various top K values, ranging from 50 to 200 with strides of 50. The values in Table 1 represent the success percentages of each shortlisting algorithm in retrieving the best (gold truth) API tool within the top K API tools retrieved by each shortlisting algorithm.

Evidently, the method of the present disclosure outperformed the other shortlisting methods with the Roberta-based IBM® Slate 30 million model exhibiting the best performance despite being small. The Roberta-based IBM® Slate 30 million model was better than all the models that were tested and finetuned.

TABLE 1
The results in columns 3 and 4 correspond to
the embodiments of the present disclosure.

| | Method | | | |
|---|---|---|---|---|
| Top K | | OOB Unified | Context Window | Context Window |
| retrieved | Semantic | Model | Method | Method |
| API tools | Shortlister | (Granite 20B) | all-miniLM-L6-v2 | IBM ® Slate 30M |
| Recall @50 | 21% | 56% | 60% | 73% |
| Recall @100 | 25% | 62% | 73% | 78% |
| Recall @150 | 27% | 68% | 77% | 82% |
| Recall @200 | 31% | 74% | 85% | 89% |

Non-limiting graph 1600 illustrates the performance evaluation results of the different shortlister algorithms on the production-like data, with tool prediction model 110 calibrated. Non-limiting graph 1700 illustrates end-to-end performance evaluation results of the different shortlister algorithms on the production-like data, with tool prediction model 110 not calibrated. It is clear from Table 1 and non-limiting graphs 1600 and 1700 that the training procedure described in one or more embodiments of the present disclosure generated a model that performed better than the existing state-of-the-art (STOA) solutions, across the board and models over existing tool chains datasets.

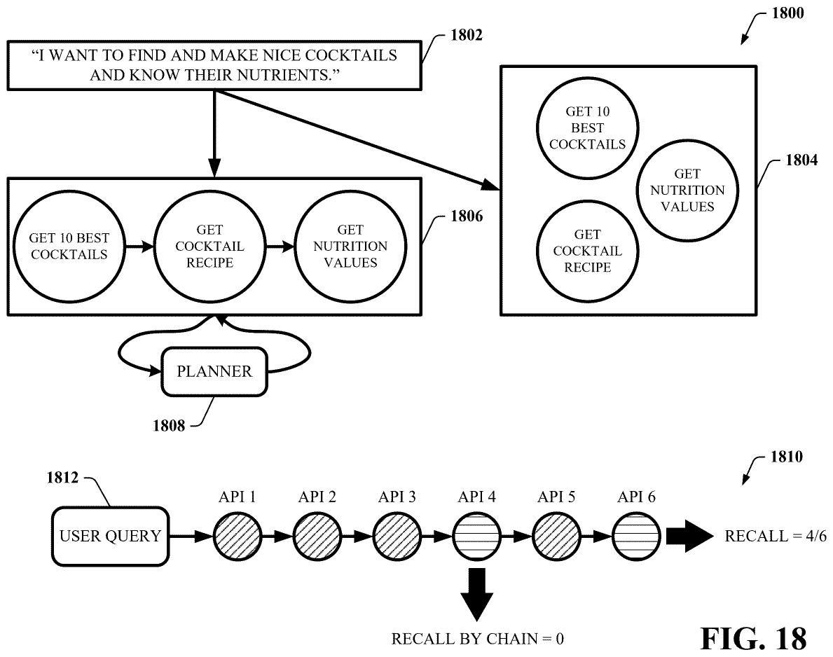

FIG. 18 illustrates a flow diagram of an example, non-limiting method 1800 that, given a query, can retrieve the best API tools for a sub-chain of API tools, and further illustrates evaluation metrics corresponding to the non-limiting method, in accordance with one or more embodiments described herein. Repetitive description of like elements and/or processes employed in respective embodiments is omitted for sake of brevity.

Non-limiting method 1800 describes additional embodiments of the NL2Seq approach discussed with reference to FIG. 13. Recall that the NL2Seq approach can retrieve top-kAPI tools in advance or iteratively, given a query. Consider query 1802, for example. Block 1804 illustrates API tools retrieved in advance based on query 1802, whereas block 1806 illustrates API tools retrieved iteratively. For example, in blocks 1804 and 1806, each circle represents a task that can be performed by an API tool. As such, each circle in blocks 1804 and 1806 represents an API tool that can be retrieved by the NL2Seq approach. The API tools in block 1804 can be retrieved via a pool retrieval, that is, by predicting top-k actions in advance. On the other hand, the same API tools in block 1806 can be retrieved in a sequential manner by employing LLM-based planning. For example, assuming that an LLM (e.g., planner 1808) can be employed in the prediction loop/sequence, wherein the LLM can predict the next API tool based on the top-k API tools, an API tool can be sequentially predicted as an NBA.

FIG. 18 further illustrates non-limiting flow diagram 1810 to describe two evaluation metrics that are relevant for the iterative retrieval of API tools wherein it is assumed that a supplementary LLM or oracle can select the NBA given retrieved top-k API tools based on a query (e.g., user query 1812). The first metric, known simply as recall, can evaluate the NL2Seq approach based on whether a model (i.e., a model employed to predict/retrieve API tools via the NL2Seq approach) can retrieve the i^{th} API tool in the top-k API tools. The second metric, known as recall by chain, can evaluate the NL2Seq approach based on whether a model can retrieve the i^{th} API tool in the top-k API tools for an entire sequence of API tools.

In the iterative retrieval approach, the order or sequence of retrieval of the API tools matters, and the recall metric is based on the next action, given the prefix of APIs already retrieved and the query (e.g., user query 1812). The recall by chain metric is somewhat similar to the recall metric, but it is much stricter because it checks whether a model has successfully retrieved an entire sequence. For example, non-limiting flow diagram 1810 illustrates that a model failed to retrieve the fourth and sixth API tools in a sequence of top-k API tools. Since the model failed to retrieved the fourth API tool, the evaluation score for the model according to the recall by chain metric is automatically zero (0). However, since the model successfully retrieved the correct API tools four times out of six, the evaluation score for the model according to the recall metric is 4/6.

Tables 2-11 illustrate preliminary results of the NL2Seq approach. The preliminary results were generated by evaluating a model on a sample of 10% of APL tool categories from ToolBench that were excluded during training of the model. For the preliminary results, the Beijing General Embedding (BGE) Large model was selected since its license allows commercial use. The BGE Large model generated good results in the retrieval task per the massive text embedding benchmark (MTEB) on Hugging Face, a collaborative platform that allows users to develop machine learning models. It was evident that the BGE Large model generated very good results for both the recall metric, and the recall by chain metric. This implies that given a good LLM that can select the NBA and execute the NBA correctly, a functioning sequence of APIs can be generated.

TABLE 2
Evaluation on a test set with the BGE
Large-EN-v1.5 as the retrieval model.

| Recall | k = 10 | k = 20 | k = 50 | k = 100 |
|---|---|---|---|---|
| N = 1000 | 0.95 | 0.96 | 0.975 | 0.98 |
| N = 2000 | 0.93 | 0.95 | 0.97 | 0.975 |
| N = 6000 | 0.89 | 0.92 | 0.945 | 0.96 |

TABLE 3
Evaluation on a test set with the BGE
Large-EN-v1.5 as the retrieval model.

| Recall | k = 10 | k = 20 | k = 50 | k = 100 |
|---|---|---|---|---|
| N = 1000 | 0.84 | 0.88 | 0.92 | 0.95 |
| N = 2000 | 0.8 | 0.85 | 0.895 | 0.92 |
| N = 6000 | 0.72 | 0.78 | 0.84 | 0.88 |

TABLE 4
Non-iterative evaluation on a test set with the BGE Large-
EN-v1.5 as the retrieval model. The results in Table 4 are
also the evaluation results based on the recall metric.

| Recall | k = 10 | k = 20 | k = 50 | k = 100 |
|---|---|---|---|---|
| N = 1000 | 0.87 | 0.91 | 0.93 | 0.95 |
| N = 2000 | 0.8 | 0.87 | 0.92 | 0.94 |
| N = 6000 | 0.62 | 0.74 | 0.86 | 0.9 |

TABLE 5
Non-iterative evaluation on a test set with
the BGE Large-EN-v1.5 as the retrieval model.

| Recall | k = 10 | k = 20 | k = 50 | k = 100 |
|---|---|---|---|---|
| N = 1000 | 0.77 | 0.83 | 0.88 | 0.9 |
| N = 2000 | 0.61 | 0.78 | 0.85 | 0.88 |
| N = 6000 | 0.2 | 0.49 | 0.76 | 0.82 |

TABLE 6
Non-iterative evaluation on a test set with
the Slate 30M as the retrieval model.

| Recall | k = 10 | k = 20 | k = 50 | k = 100 |
|---|---|---|---|---|
| N = 1000 | 0.75 | 0.86 | 0.94 | 0.97 |
| N = 2000 | 0.64 | 0.75 | 0.89 | 0.94 |
| N = 6000 | 0.5 | 0.59 | 0.72 | 0.83 |

TABLE 7
Non-iterative evaluation on a test set with
the Slate 30M as the retrieval model.

| Recall | k = 10 | k = 20 | k = 50 | k = 100 |
|---|---|---|---|---|
| N = 1000 | 0.35 | 0.62 | 0.85 | 0.93 |
| N = 2000 | 0.15 | 0.35 | 0.71 | 0.85 |
| N = 6000 | 0.03 | 0.09 | 0.3 | 0.56 |

Tables 8 and 9 list results of the non-iterative evaluation on a test set with the Slate 30M (version: 02282024) as the retrieval model. The test set comprised 10% of the categories from the Reproduced ToolBench. The main updates for these evaluations were that the finish API step was removed, and the number of epochs were increased.

TABLE 8

| Recall | N = 1000 | N = 2000 | N = 6000 |
|---|---|---|---|
| Recall@10 | 0.7942 | 0.71714 | 0.59454 |
| Recall@20 | 0.86002 | 0.79608 | 0.67639 |
| Recall@50 | 0.9231 | 0.88167 | 0.77715 |
| Recall@100 | 0.95737 | 0.9214 | 0.84689 |

TABLE 9

| Recall | N = 1000 | N = 2000 | N = 6000 |
|---|---|---|---|
| Recall@10 | 0.63549 | 0.53439 | 0.41678 |
| Recall@20 | 0.73384 | 0.6458 | 0.49862 |
| Recall@50 | 0.85213 | 0.77442 | 0.62724 |
| Recall@100 | 0.91816 | 0.85213 | 0.71939 |

Tables 10 and 11 lists the evaluation results based on API-BANK which is out of distribution (OOD). The model was tested on level 3 tool chains with 50 manually annotated API tool chains, 181 predictions, multiple APIs and multiple calls. These scores are somewhat lower, which indicates the importance of collecting the relevant training data for API tool retrieval to generate more desirable results. However, it should be noted that these are preliminary results, and the performance of the model can be potentially improved in such scenarios.

TABLE 10

| Recall | k = 10 | k = 20 | k = 50 | k = 100 |
|---|---|---|---|---|
| N = 1000 | 0.7 | 0.75 | 0.81 | 0.88 |
| N = 2000 | 0.64 | 0.72 | 0.76 | 0.82 |

TABLE 11

| Recall | k = 10 | k = 20 | k = 50 | k = 100 |
|---|---|---|---|---|
| N = 1000 | 0.4 | 0.44 | 0.54 | 0.66 |
| N = 2000 | 0.3 | 0.4 | 0.46 | 0.58 |

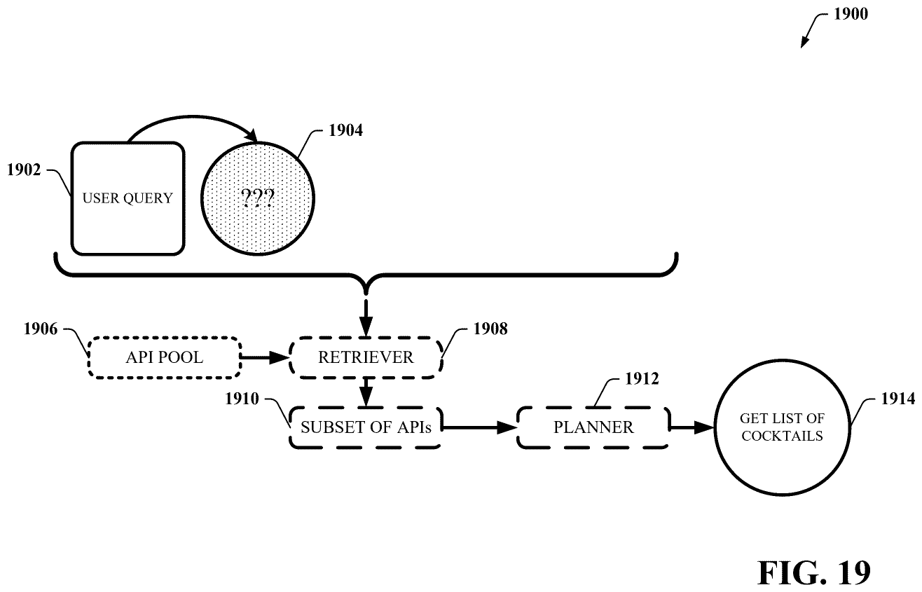

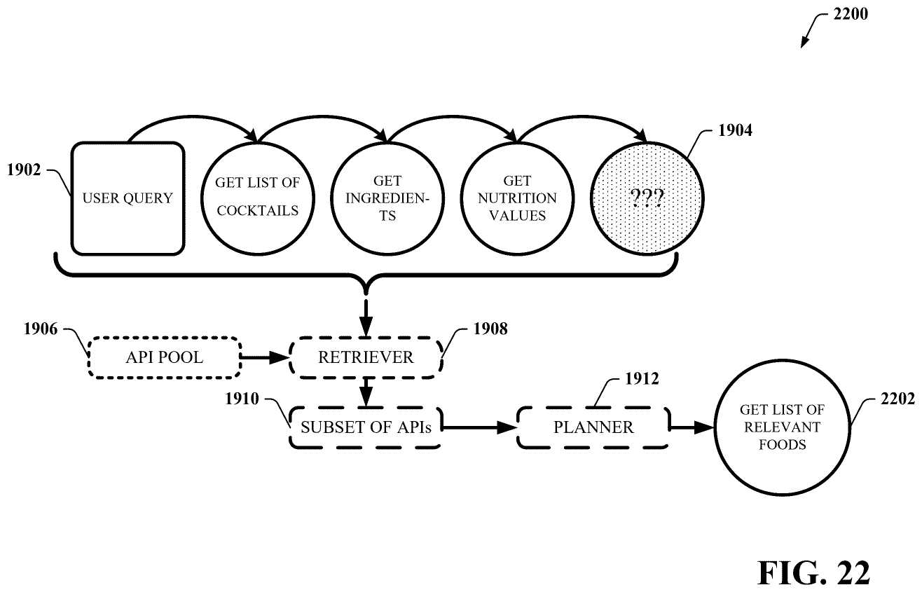

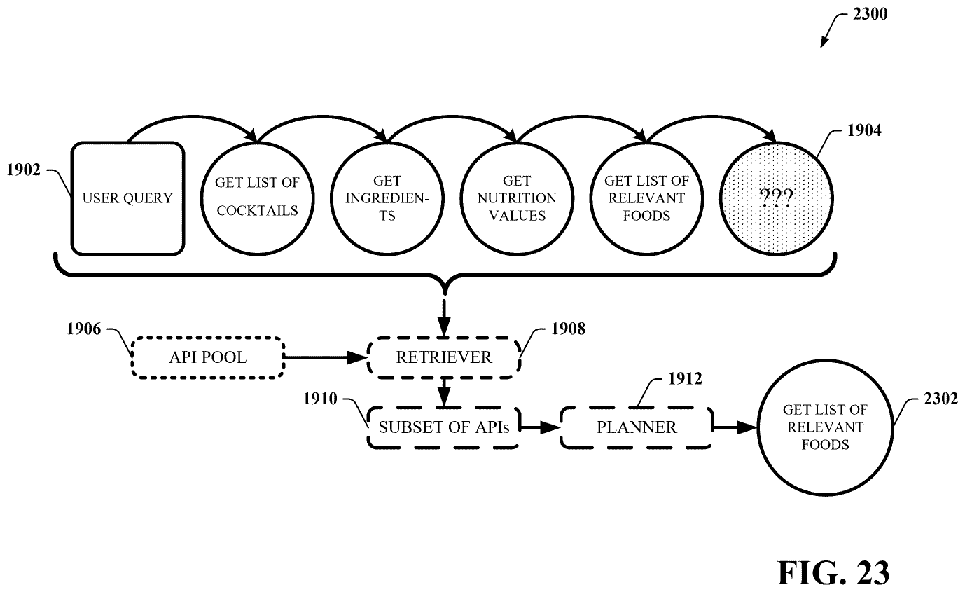

FIGS. 19-23 illustrate flow diagrams of example, non-limiting steps of a method that, given a query, can retrieve the best API tool for a sub-chain of API tools, in accordance with one or more embodiments described herein. Repetitive description of like elements and/or processes employed in respective embodiments is omitted for sake of brevity.

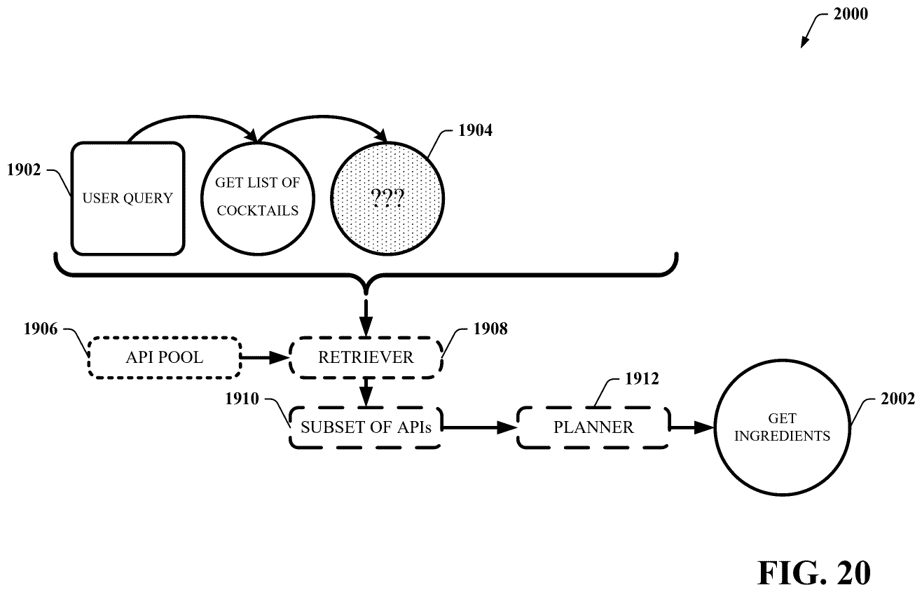

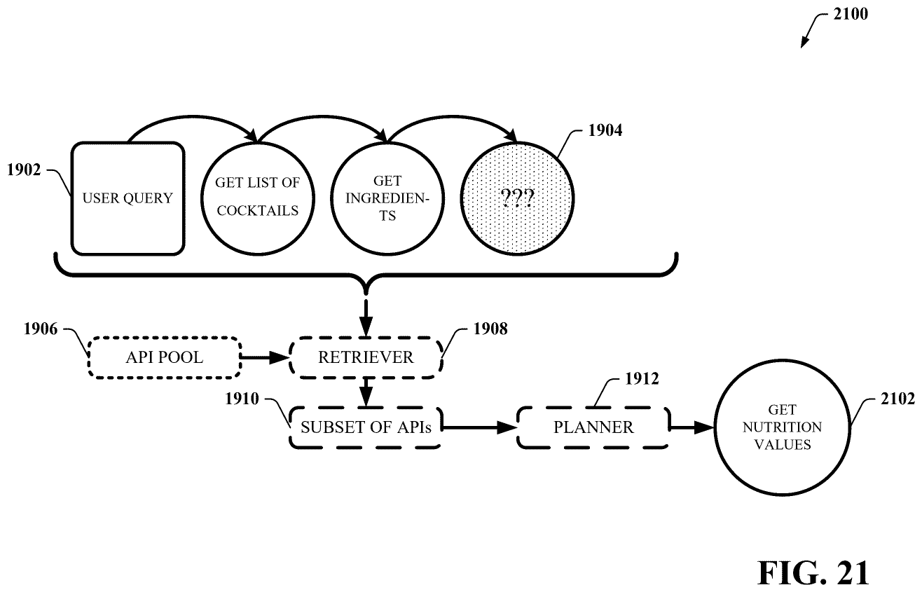

Specifically, FIGS. 19-23 illustrate the steps involved in the iterative method of retrieving API tools via the NL2Seq approach. As described in one or more embodiments herein, a sequence of API tools can be retrieved via the NL2Seq approach by assuming an LLM that can take as input, top-k API tools that have been retrieved, and select the next API tool in the sequence. For example, referring to non-limiting step 1900 of FIG. 19, a retrieval model (e.g., retriever 1908) can be queried, based on a query (e.g., user query 1902) provided by an entity (e.g., hardware, software, machine, AI, neural network and/or user), to retrieve a subset of API tools (e.g., subset of APIs 1910) from API pool 1906. The subset of API tools can be input to an LLM (e.g., planner 1912) that can output the NBA. For example, planner 1912 can retrieve API tool 1914 as the first API tool (at position 1904) within a sequence of API tools. This process can be repeated sequentially for the entire sequence of API tools. For example, non-limiting step 1900 can be followed by non-limiting step 2000 of FIG. 20, wherein planner 1912 can retrieve API tool 2002 as the second API tool (at the new position 1904) within the sequence of API tools. Similarly, non-limiting step 2000 can be followed by non-limiting steps 2100, 2200 and 2300 of FIGS. 21, 22 and 23, respectively, wherein planner 1912 can retrieve API tools 2102, 2202 and 2302 as the third, fourth and fifth API tools, respectively, in the sequence of API tools.

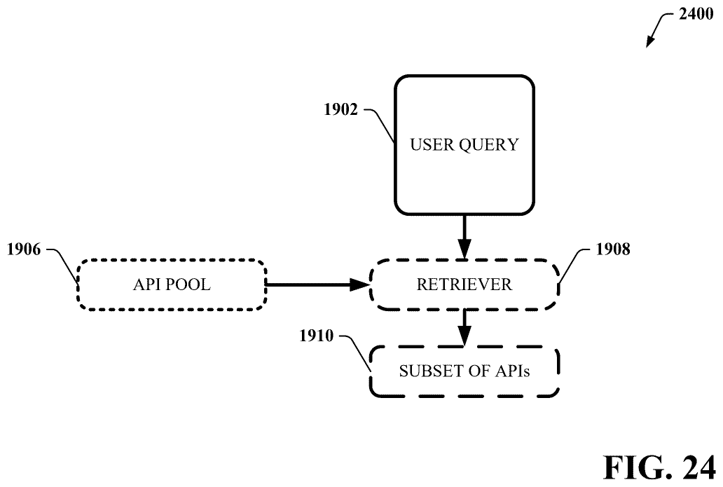

FIG. 24 illustrates a flow diagram of an example, non-limiting method 2400 that, given a query, can retrieve a subset of the best API tools, in accordance with one or more embodiments described herein. Repetitive description of like elements and/or processes employed in respective embodiments is omitted for sake of brevity.

FIG. 24 illustrates an alternative method of retrieving API tools via the NL2Seq approach. For example, given user query 1902, retriever 1908 can retrieve the subset of APIs 1910 from API pool 1906, in advance, for an entire sequence of API tools, as opposed to sequentially retrieving individual API tools.

In one or more embodiments, a graph of APIs for a planner can be generated. Further, in one or more embodiments, classic search algorithms can be augmented.

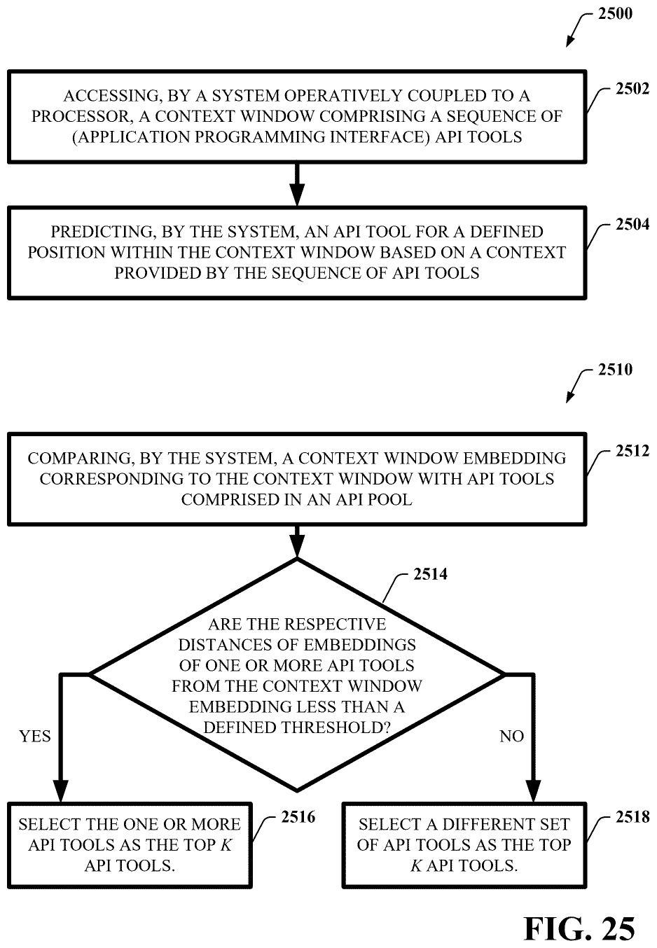

FIG. 25 illustrates flow diagrams of example, non-limiting methods 2500 and 2510 that can be employed to predict an API tool that can be employed at a defined position within a context window, in accordance with one or more embodiments described herein. Repetitive description of like elements and/or processes employed in respective embodiments is omitted for sake of brevity.

At 2502, non-limiting method 2500 can comprise accessing (e.g., by access component 204), by a system operatively coupled to a processor, a context window comprising a sequence of API tools.

At 2504, non-limiting method 2500 can comprise predicting (e.g., by prediction component 206), by the system, an API tool for a defined position within the context window based on a context provided by the sequence of API tools.

In various embodiments, the API tool can be predicted by first identifying top K API tools from an API pool, as illustrated by non-limiting method 2510.

For example, at 2512, non-limiting method 2510 can comprise comparing (e.g., by prediction component 206), by the system, a context window embedding corresponding to the context window with API tools comprised in an API pool, wherein the API pool can comprise a plurality of API tools.

At 2514, non-limiting method 2510 can comprise determining (e.g., by prediction component 206), by the system, whether respective distances of embeddings of one or more API tools comprised in the API pool from the context window embedding are less than a defined threshold.

If yes, then at 2516, non-limiting method 2510 can comprise selecting (e.g., by prediction component 206), by the system, the one or more API tools as the top K API tools.

If not, then at 2518, non-limiting method 2510 can comprise selecting (e.g., by prediction component 206), by the system, a different set of API tools as the top K API tools. For example, the system can continue to search for API tools having embeddings whose distances from the context window embedding are less than the defined threshold.

Thereafter, the API tool predicted at 2504 can be selected from the top KAPI tools.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ AI to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

FIG. 26 illustrates a block diagram of an example, non-limiting, operating environment 2600 in which one or more embodiments described herein can be facilitated. FIG. 26 and the following discussion are intended to provide a general description of a suitable operating environment 2600 in which one or more embodiments described herein at FIGS. 1-13 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 2600 contains an example of an environment for the execution of at least some of the computer code involved in performing the inventive methods, such as Application Programming Interface (API) tool prediction code 2628. In addition to block 2628, computing environment 2600 includes, for example, computer 2601, wide area network (WAN) 2602, end user device (EUD) 2603, remote server 2604, public cloud 2605, and private cloud 2606. In this embodiment, computer 2601 includes processor set 2610 (including processing circuitry 2620 and cache 2621), communication fabric 2611, volatile memory 2612, persistent storage 2613 (including operating system 2622 and block 2628, as identified above), peripheral device set 2614 (including user interface (UI) device set 2623, storage 2624, and Internet of Things (IoT) sensor set 2625), and network module 2615. Remote server 2604 includes remote database 2630. Public cloud 2605 includes gateway 2640, cloud orchestration module 2641, host physical machine set 2642, virtual machine set 2643, and container set 2644.

COMPUTER 2601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 2630. As is well understood in the art of computer technology, and depending upon the technology, performance of a computer-implemented method may be distributed among multiple computers and/or between multiple locations. On the other hand, in this presentation of computing environment 2600, detailed discussion is focused on a single computer, specifically computer 2601, to keep the presentation as simple as possible. Computer 2601 may be located in a cloud, even though it is not shown in a cloud in FIG. 26. On the other hand, computer 2601 is not required to be in a cloud except to any extent as may be affirmatively indicated.

PROCESSOR SET 2610 includes one, or more, computer processors of any type now known or to be developed in the future. Processing circuitry 2620 may be distributed over multiple packages, for example, multiple, coordinated integrated circuit chips. Processing circuitry 2620 may implement multiple processor threads and/or multiple processor cores. Cache 2621 is memory that is located in the processor chip package(s) and is typically used for data or code that should be available for rapid access by the threads or cores running on processor set 2610. Cache memories are typically organized into multiple levels depending upon relative proximity to the processing circuitry. Alternatively, some, or all, of the cache for the processor set may be located “off chip.” In some computing environments, processor set 2610 may be designed for working with qubits and performing quantum computing.

Computer-readable program instructions are typically loaded onto computer 2601 to cause a series of operational steps to be performed by processor set 2610 of computer 2601 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 2621 and the other storage media discussed below. The program instructions, and associated data, are accessed by processor set 2610 to control and direct performance of the inventive methods. In computing environment 2600, at least some of the instructions for performing the inventive methods may be stored in block 2628 in persistent storage 2613.

COMMUNICATION FABRIC 2611 is the signal conduction path that allows the various components of computer 2601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 2612 is any type of volatile memory now known or to be developed in the future. Examples include dynamic type random access memory (RAM) or static type RAM. Typically, volatile memory 2612 is characterized by random access, but this is not required unless affirmatively indicated. In computer 2601, the volatile memory 2612 is located in a single package and is internal to computer 2601, but, alternatively or additionally, the volatile memory may be distributed over multiple packages and/or located externally with respect to computer 2601.

PERSISTENT STORAGE 2613 is any form of non-volatile storage for computers that is now known or to be developed in the future. The non-volatility of this storage means that the stored data is maintained regardless of whether power is being supplied to computer 2601 and/or directly to persistent storage 2613. Persistent storage 2613 may be a read only memory (ROM), but typically at least a portion of the persistent storage allows writing of data, deletion of data and re-writing of data. Some familiar forms of persistent storage include magnetic disks and solid state storage devices. Operating system 2622 may take several forms, such as various known proprietary operating systems or open source Portable Operating System Interface-type operating systems that employ a kernel. The code included in block 2628 typically includes at least some of the computer code involved in performing the inventive methods.

PERIPHERAL DEVICE SET 2614 includes the set of peripheral devices of computer 2601. Data communication connections between the peripheral devices and the other components of computer 2601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 2623 may include components such as a display screen, speaker, microphone, wearable devices (such as goggles and smart watches), keyboard, mouse, printer, touchpad, game controllers, and haptic devices. Storage 2624 is external storage, such as an external hard drive, or insertable storage, such as an SD card. Storage 2624 may be persistent and/or volatile. In some embodiments, storage 2624 may take the form of a quantum computing storage device for storing data in the form of qubits. In embodiments where computer 2601 is required to have a large amount of storage (for example, where computer 2601 locally stores and manages a large database) then this storage may be provided by peripheral storage devices designed for storing very large amounts of data, such as a storage area network (SAN) that is shared by multiple, geographically distributed computers. IoT sensor set 2625 is made up of sensors that can be used in Internet of Things applications. For example, one sensor may be a thermometer and another sensor may be a motion detector.

NETWORK MODULE 2615 is the collection of computer software, hardware, and firmware that allows computer 2601 to communicate with other computers through WAN 2602. Network module 2615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 2615 are performed on the same physical hardware device. In other embodiments (for example, embodiments that utilize software-defined networking (SDN)), the control functions and the forwarding functions of network module 2615 are performed on physically separate devices, such that the control functions manage several different network hardware devices. Computer-readable program instructions for performing the inventive methods can typically be downloaded to computer 2601 from an external computer or external storage device through a network adapter card or network interface included in network module 2615.

WAN 2602 is any wide area network (for example, the internet) capable of communicating computer data over non-local distances by any technology for communicating computer data, now known or to be developed in the future. In some embodiments, the WAN 2602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 2603 is any computer system that is used and controlled by an end user (for example, a customer of an enterprise that operates computer 2601), and may take any of the forms discussed above in connection with computer 2601. EUD 2603 typically receives helpful and useful data from the operations of computer 2601. For example, in a hypothetical case where computer 2601 is designed to provide a recommendation to an end user, this recommendation would typically be communicated from network module 2615 of computer 2601 through WAN 2602 to EUD 2603. In this way, EUD 2603 can display, or otherwise present, the recommendation to an end user. In some embodiments, EUD 2603 may be a client device, such as thin client, heavy client, mainframe computer, desktop computer and so on.

REMOTE SERVER 2604 is any computer system that serves at least some data and/or functionality to computer 2601. Remote server 2604 may be controlled and used by the same entity that operates computer 2601. Remote server 2604 represents the machine(s) that collect and store helpful and useful data for use by other computers, such as computer 2601. For example, in a hypothetical case where computer 2601 is designed and programmed to provide a recommendation based on historical data, then this historical data may be provided to computer 2601 from remote database 2630 of remote server 2604.

PUBLIC CLOUD 2605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 2605 is performed by the computer hardware and/or software of cloud orchestration module 2641. The computing resources provided by public cloud 2605 are typically implemented by virtual computing environments that run on various computers making up the computers of host physical machine set 2642, which is the universe of physical computers in and/or available to public cloud 2605. The virtual computing environments (VCEs) typically take the form of virtual machines from virtual machine set 2643 and/or containers from container set 2644. It is understood that these VCEs may be stored as images and may be transferred among and between the various physical machine hosts, either as images or after instantiation of the VCE. Cloud orchestration module 2641 manages the transfer and storage of images, deploys new instantiations of VCEs and manages active instantiations of VCE deployments. Gateway 2640 is the collection of computer software, hardware, and firmware that allows public cloud 2605 to communicate through WAN 2602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 2606 is similar to public cloud 2605, except that the computing resources are only available for use by a single enterprise. While private cloud 2606 is depicted as being in communication with WAN 2602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 2605 and private cloud 2606 are both part of a larger hybrid cloud.

CLOUD COMPUTING SERVICES AND/OR MICROSERVICES (not separately shown in FIG. 26): private and public clouds 2606 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an access component that accesses a context window comprising a sequence of application programming interface (API) tools; and
a prediction component that predicts an API tool for a defined position within the context window, based on a context provided by the sequence of API tools.

2. The system of claim 1, wherein the prediction component is an artificial intelligence (AI) model, and wherein the system further comprises:
a training component that trains the AI model to predict the API tool, wherein training the AI model comprises:
generating, by the training component, a training dataset comprising sub-chains of API tools, contextual information related to the sub-chains of API tools, positive samples and negative samples, wherein the positive samples represent first API tools that are suitable for the defined position, and wherein the negative samples represent second API tools that are unsuitable for the defined position; and
training, by the training component, based on the training dataset, the AI model to minimize an embedding distance between the context window and a tool embedding of a positive sample, while maximizing the embedding distance to the negative samples.

3. The system of claim 2, wherein the training component employs hard negative sampling mechanisms to generate the negative samples.

4. The system of claim 2, wherein the training enhances an ability of the AI model to infer, based only on the context associated with the sequence of API tools, a task objective associated with the sequence of API tools.

5. The system of claim 2, wherein the training further enhances an understanding of the AI model regarding functionalities of API tools comprised in the training dataset.

6. The system of claim 1, wherein the context window represents a sub-chain within a set of sub-chains, and wherein the prediction component predicts respective API tools for respective sub-chains comprised in the set of sub-chains, based on respective contexts of the respective sub-chains, such that predicting the respective API tools for the respective sub-chains completes a tool chain.

7. The system of claim 6, further comprising:
a sub-chain generation component that generates the set of sub-chains from the tool chain via a sliding window approach with a defined number of stride steps.

8. The system of claim 6, wherein the respective API tools are employable to execute respective actions.

9. The system of claim 1, further comprising:
an execution component that executes the API tool, wherein execution of the API tool generates an outcome, and wherein the outcome is accessible as input data by a subsequent API tool in the sequence of API tools.

10. A computer-implemented method, comprising:
accessing, by a system operatively coupled to a processor, a context window comprising a sequence of API tools; and
predicting, by the system, an API tool for a defined position within the context window, based on a context provided by the sequence of API tools.

11. The computer-implemented method of claim 10, wherein the predicting is performed by an AI model, and wherein the computer-implemented method further comprises:
training, by the system, the AI model to predict the API tool, wherein the training comprises:
generating, by the system, a training dataset comprising sub-chains of API tools, contextual information related to the sub-chains of API tools, positive samples and negative samples, wherein the positive samples represent first API tools that are suitable for the defined position, and wherein the negative samples represent second API tools that are unsuitable for the defined position; and
training, by the system, based on the training dataset, the AI model to minimize an embedding distance between the context window and a tool embedding of a positive sample, while maximizing the embedding distance to the negative samples.

12. The computer-implemented method of claim 11, further comprising:
generating, by the system, the negative samples via hard negative sampling mechanisms.

13. The computer-implemented method of claim 11, wherein the training the AI model enhances an ability of the AI model to infer, based only on the context associated with the sequence of API tools, a task objective associated with the sequence of API tools.

14. The computer-implemented method of claim 11, wherein the training the denser retriever model further enhances an understanding of the AI model regarding functionalities of API tools comprised in the training dataset.

15. The computer-implemented method of claim 10, wherein the context window represents a sub-chain within a set of sub-chains, and wherein the computer-implemented method further comprises:
predicting, by the system, respective API tools for respective sub-chains comprised in the set of sub-chains, based on respective contexts of the respective sub-chains, such that the predicting the respective API tools for the respective sub-chains completes a tool chain.

16. The computer-implemented method of claim 15, further comprising:
generating, by the system, the set of sub-chains from the tool chain via a sliding window approach with a defined number of stride steps.

17. The computer-implemented method of claim 15, wherein the respective API tools are employable to execute respective actions.

18. The computer-implemented method of claim 10, further comprising:
executing, by the system, the API tool, wherein the executing generates an outcome, and wherein the outcome is accessible as input data by a subsequent API tool in the sequence of API tools.

19. A computer program product for context-aware predictive tool sequencing, the computer program product comprising a computer readable storage medium having program instructions embodied therewith, the program instructions executable by a processor to cause the processor to:
access, by the processor, a context window comprising a sequence of API tools; and
predict, by the processor, an API tool for a defined position within the context window, based on a context of the sequence of API tools.

20. The computer program product of claim 19, wherein the API tool is predicted via an AI model, and wherein the program instructions are further executable by the processor to cause the processor to:
train, by the processor, the AI model to predict the API tool, wherein training the AI model comprises:
generating, by the processor, a training dataset comprising sub-chains of API tools, contextual information related to the sub-chains of API tools, positive samples and negative samples, wherein the positive samples represent first API tools that are suitable for the defined position, and wherein the negative samples represent second API tools that are unsuitable for the defined position; and
training, by the processor, based on the training dataset, the AI model to minimize an embedding distance between the context window and a tool embedding of a positive sample, while maximizing the embedding distance to the negative samples.
